(19) United States
(12) Patent Application Publication
(10) Pub. No.: US 2026/0046322 A1
(43) Pub. Date: Feb. 12, 2026

(54) ENHANCEMENTS OF RADIO ACCESS NETWORK TO FACILITATE FEDERATED LEARNING

(71) Applicant: Dell Products L.P., Round Rock, TX (US)

(72) Inventor: Prashanth Murthy, Plano, TX (US)

(21) Appl. No.: 18/797,457

(22) Filed: Aug. 7, 2024

(51) Int. Cl. H04L 65/1069; H04L 69/322; H04W 24/02

(52) U.S. Cl. CPC H04L 65/1069; H04L 69/322; H04W 24/02

(57) ABSTRACT

RAN, and distributed and federated learning, can be enhanced. Session manager can initiate establishing PDU session between UE and RAN. PDU session is associated with PDU session type corresponding to type value associated with RAN to indicate PDU session can terminate at RAN. Using DRB associated with PDU session, RAN and UE can communicate unstructured data to each other. RAN can comprise global AI component comprising global AI model. UEs can comprise local AI components comprising local AI models. Global AI component can train global AI model based on respective first AI-related data generated by local AI models and received from respective UEs. Global AI component can train global AI model based on respective first AI-related data, and trained global AI model can generate second AI-related data. RAN can take action based on second AI-related data or can communicate second AI-related data to UE to update local AI model.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise initiating, by a system comprising at least one processor, establishing a protocol data unit session between a device and a radio access network node of a radio access network, the protocol data unit session having a protocol data unit session type that can correspond to a value that can indicate the radio access network, wherein the protocol data unit session can terminate at the radio access network. The method also can comprise facilitating, by the system and using a data radio bearer associated with the protocol data unit session, communicating unstructured data between the radio access network node and the device.

In certain embodiments, the disclosed subject matter can comprise a system that can comprise at least one memory that can store computer executable components, and at least one processor that can execute computer executable components stored in the at least one memory. The computer executable components can comprise a radio access network node of a radio access network. The computer executable components also can comprise a session manager that can initiate establishment of a protocol data unit session between a user equipment and the radio access network node, wherein the protocol data unit session can be associated with a protocol data unit session type that can correspond to a type value associated with the radio access network to indicate that the protocol data unit session can terminate at the radio access network node. The radio access network node, using a data radio bearer associated with the protocol data unit session, can transmit unstructured information to the user equipment.

In still other embodiments, the disclosed subject matter can comprise a non-transitory machine-readable medium, comprising executable instructions that, when executed by at least one processor, can facilitate performance of operations. The operations can comprise facilitating a protocol data unit session between a user equipment and a base station of a radio access network, the protocol data unit session can be associated with a protocol data unit session type that can correspond to a session type value that can indicate the radio access network, wherein the protocol data unit session can terminate at the base station. The operations also can comprise communicating, using a data radio bearer associated with the protocol data unit session, unstructured data, which can comprise unstructured artificial intelligence-related data, between the base station and the user equipment.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage and generate enhanced protocol data unit (PDU) sessions between a radio access network (RAN) and devices to facilitate exchange of data between the RAN and the devices, in accordance with various aspects and embodiments of the disclosed subject matter.

FIG. 2 depicts a block diagram of a non-limiting example system that can desirably employ an enhanced PDU session between the RAN and the device, and can manage and perform distributed and federated learning, using the enhanced PDU session, to facilitate training and updating a global artificial intelligence (AI) model associated with the RAN and a local AI model associated with a device, in accordance with various aspects and embodiments of the disclosed subject matter.

FIG. 3 illustrates a block diagram of a non-limiting example system that can employ an enhanced PDU session and associated quality of service (QoS) architecture, wherein the enhanced PDU session can desirably terminate at the RAN, in accordance with various aspects and embodiments of the disclosed subject matter.

FIG. 4 depicts a block diagram of a non-limiting example system that can desirably employ an enhanced PDU session between the RAN and the device that can terminate at the RAN, to facilitate exchanging data between the RAN and the device and/or facilitate training and updating a global AI model associated with the RAN and a local AI model associated with a device, wherein the system can operate without a user plane function (UPF) having to be collocated in a same local data network as the base station and the global AI component of the RAN, in accordance with various aspects and embodiments of the disclosed subject matter.

FIG. 5 depicts a diagram of a non-limiting example process flow that can demonstrate example interactions of network elements in connection with performing distributed and federated learning, including the exchange of data, comprising AI-related data, between the RAN and the device (and associated AI components and AI/machine learning (ML) applications), in accordance with various aspects and embodiments of the disclosed subject matter.

FIG. 6 illustrates a block diagram of a non-limiting example protocol stacks associated with the base station and the device that can be utilized to facilitate the exchanging of data between the global AI component (and its associated AI/ML application) and the local AI component (and its associated AI/ML application) to facilitate distributed and federated learning, in accordance with various aspects and embodiments of the disclosed subject matter.

FIG. 7 depicts a block diagram of a non-limiting example AI component that can perform AI-based analysis on data and generate AI-based analysis results, in accordance with various aspects and embodiments of the disclosed subject matter.

FIG. 8 illustrates a block diagram of a non-limiting example system that can desirably manage, facilitate performing, and/or facilitate initiating or establishing enhanced PDU sessions between the RAN and devices to facilitate distributed and federated learning, in accordance with various aspects and embodiments of the disclosed subject matter.

FIG. 9 depicts a block diagram of non-limiting example system that can employ enhanced PDU sessions between a device and a base station in an open RAN (O-RAN) communication network environment to facilitate desirable management and performance of distributed and federated learning to facilitate training and updating a global AI model of a base station of the RAN(s) and local AI models of devices associated with the RAN(s), in accordance with various aspects and embodiments of the disclosed subject matter.

FIG. 10 depicts a diagram of a non-limiting example base station that can desirably facilitate connections and communication of information associated with devices, in accordance with various aspects and embodiments of the disclosed subject matter.

FIG. 11 illustrates a diagram of a non-limiting example device that can be operable to engage in a system architecture that facilitates wireless communications according to one or more embodiments described herein, in accordance with various aspects and embodiments of the disclosed subject matter.

FIG. 12 illustrates a flow chart of an example method that can desirably establish an enhanced PDU session between the RAN and a device to facilitate communication of data between the RAN and the device, and facilitate distributed and federated learning, in accordance with various aspects and embodiments of the disclosed subject matter.

FIGS. 13 and 14 depict a flow chart of another example method that can desirably establish an enhanced PDU session between the RAN and a device to facilitate communication of data between the RAN and the device, and facilitate distributed and federated learning, in accordance with various aspects and embodiments of the disclosed subject matter.

FIG. 15 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that can enhance a radio access network (RAN) and protocol data unit (PDU) sessions associated with the RAN and devices to facilitate desirable exchange of data between the RAN and devices to facilitate and support distributed and federated learning, including artificial intelligence (AI) and machine learning (ML) learning, with respect to the RAN and devices and to facilitate and support other desired uses that can involve such exchange of data between the RAN and devices. In 5th generation (5G) new radio (NR), in the RAN, one objective can be to improve network performance and user experience using data that can be collected and processed autonomously. Certain AI/ML use cases have been identified for deployment in the following scenarios: AI/ML model training can be located in an operations, administration, and management (OAM) node, and AI/ML model inference can be located in the RAN node (e.g., NG-RAN node, such as a base station); and AI/ML model training and AI/ML model inference can both be located in the RAN node.

Existing systems and techniques can be deficient in a number of ways. One deficiency of existing systems and techniques can be the undesirably limited scope of distributed and federated learning. For instance, with some existing systems and techniques, distributed and federated learning can be limited to the application layer, wherein a global model (e.g., global AI/ML model in the cloud (e.g., in a core network or data network)) can aggregate local models that can be partially trained in the user equipment (UE), and the global model can be updated based on UE feedback. However, with such existing systems and techniques, the local AI model of the UE ends up having to perform at least some part of the compute-intensive processing involved in the AI model training and inferencing, which can be undesirable (e.g., deficient, inefficient, suboptimal, or otherwise undesirable). Another deficiency of existing systems and techniques can relate to an undesirably (e.g., unsuitably, inefficiently, deficiently, or suboptimally) limiting scope of communication of data (e.g., unstructured AI-related data and/or other unstructured data) between a RAN and devices.

It can be desirable (e.g., suitable, beneficial, advantageous, useful, improved, or optimal) if the communication of data, including AI-related data, between the RAN and devices can be enhanced. It also can be desirable if the scope of distributed and federated learning can be expanded in the RAN. The systems, methods, and techniques disclosed herein desirably can enhance the communication of data, including AI-related data, between the RAN and devices, and can expand the scope of distributed and federated learning in the RAN.

Accordingly, the disclosed subject matter can address and overcome the aforementioned deficiencies and other deficiencies of the existing systems and techniques. To that end, techniques that can desirably (e.g., automatically, dynamically, suitably, reliably, efficiently, enhancedly, and/or optimally) enhance the RAN, enhance management and performance of distributed and federated learning to facilitate training and updating a global AI model of the RAN and respective local AI models associated with respective devices associated with the RAN, are presented. A system can comprise a communication network that can comprise one or more RANs. A RAN can comprise one or more base stations that can facilitate communication (e.g., wireless communication) of data between devices associated with the communication network (e.g., communicatively connected to a base station of the communication network, or otherwise connected to the communication network).

The communication network can comprise a core network that can be associated with (e.g., communicatively connected to) the one or more RANs. The core network can comprise various network functions, components, and equipment that can facilitate communication of information between devices associated with the core network and/or the communication network.

In some embodiments, the core network can comprise a session manager component that can establish, or can initiate or facilitate establishing, a PDU session (e.g., an enhanced PDU session) between a device and the RAN (e.g., in response to a PDU session request received from the device), wherein the PDU session can be associated with a PDU session type that can correspond to a type value (e.g., PDU session type value) that can be associated with the RAN to indicate that the PDU session can terminate at the RAN. In connection with the establishing of the PDU session, the RAN can set up (e.g., establish or create) a data radio bearer(s) (DRB(s)) associated with the PDU session for the QoS flow(s) for data traffic between the RAN and the device based at least in part on desired (e.g., suitable, applicable, usable, or optimal) QoS parameters (e.g., which can be received from the core network) and/or other parameters (e.g., network-related parameters, device-related parameters, and/or parameters relating to user or device preferences) associated with the data traffic. Using the DRB(s) associated with the PDU session (e.g., enhanced PDU session with the type value associated with the RAN), the RAN and the device can communicate or exchange unstructured data between each other.

In some embodiments, the RAN can comprise a global AI component and associated global AI model, and one or more devices, comprising the device, associated with the RAN (or another RAN) can comprise respective local AI components and associated local AI models. In certain embodiments, the RAN and the device can utilize the PDU session to communicate AI-related data and/or other data between the RAN (and its associated global AI component and global AI model) and the device (and its associated local AI component and local AI model) to facilitate desirable distributed, federated, and/or collaborative learning between the global AI component (and associated global AI model) associated with the RAN and the local AI component (and associated local AI model) associated with the device to facilitate respective training and updating (e.g., iterative training and updating) of the global AI model and local AI model. The disclosed subject matter can enable the RAN and associated global AI component to do the same or similar distributed, federated, and/or collaborative learning with one or more other devices and associated local AI components using the enhanced PDU sessions (e.g., PDU session associated with the PDU session type that can correspond to the type value indicating the RAN) described herein.

In some embodiments, the local AI model (e.g., trained local AI model) associated with the device can generate first AI-related data that can relate to the device, the base station and/or another base station, the RAN and/or another RAN, and/or the core network. Using the DRB associated with the PDU session (e.g., enhanced PDU session), the device can communicate the first AI-related data to the base station. The device also can communicate other data (e.g., measurement data relating to communication conditions associated with the device and/or other data) to the base station. The base station can determine RAN-related data based at least in part on the measurement data and/or other data. The global AI model (e.g., trained global AI model) can receive and analyze (e.g., perform an AI-based analysis on) the first AI-related data, the RAN-related data, the measurement data, and/or other data (e.g., another AI-related data from another device(s), other RAN-related data received from another RAN, other measurement data received from another device(s)), and, as part of such analysis, the global AI model can be trained and/or updated, and/or the trained and/or updated global AI model can generate second AI-related data that can relate to the device and/or another device, the base station and/or another base station, the RAN and/or another RAN, and/or the core network.

In certain embodiments, the RAN (e.g., the base station or other part of the RAN) can perform an action with respect to the RAN, the device, and/or another device based at least in part on the second AI-related data. For example, as part of the action, the base station can communicate, to the device, information relating to a prediction or inference relating to operations, functions, parameters, and/or other features of the device to facilitate controlling or modifying operation, functionality, or a parameter(s) of the device. In certain other embodiments, the base station can communicate the second AI-related data to the device, and the device can forward the second AI-related data to its associated local AI component, wherein the local AI component can update (e.g., update or refine the training of) the trained local AI model based at least in part on the second AI-related data (e.g., based at least in part on the results of an AI-based analysis of the second AI-related data by the local AI model). In some embodiments, the trained and updated local AI model can generate third AI-related data that can comprise a prediction or inference relating to operations, functions, parameters, and/or other features of the device, and the device can control or modify operation, functionality, or a parameter(s) of the device based at least in part on the third AI-related data.

The disclosed subject matter, by employing the session manager component, the enhanced PDU session, and the enhanced techniques described herein, can desirably (e.g., automatically, dynamically, suitably, reliably, efficiently, enhancedly, and/or optimally) communicate data (e.g., unstructured PDUs), including AI-related data, between the RAN and devices. The disclosed subject matter, by employing the enhanced PDU sessions, and the enhanced techniques described herein, also can desirably enhance distributed, federated, and/or collaborative learning, comprising training or updating a global AI model of the RAN based at least in part on AI-related data received from the device(s), and/or training or updating a local AI model of the device based at least in part on AI-related data received from the RAN. The disclosed subject matter, by employing the enhanced PDU sessions, the enhanced techniques described herein, and the enhanced trained or updated global AI model of the RAN and the enhanced trained or updated local AI models of the devices, further can desirably perform enhanced predictions, inferences, and/or determinations relating to operations, functions, parameters, or features of the RAN(s), device(s), and the core network, and can enhance overall performance of the RAN(s), device(s), and the core network.

These and other aspects and embodiments of the disclosed subject matter will now be described with respect to the drawings.

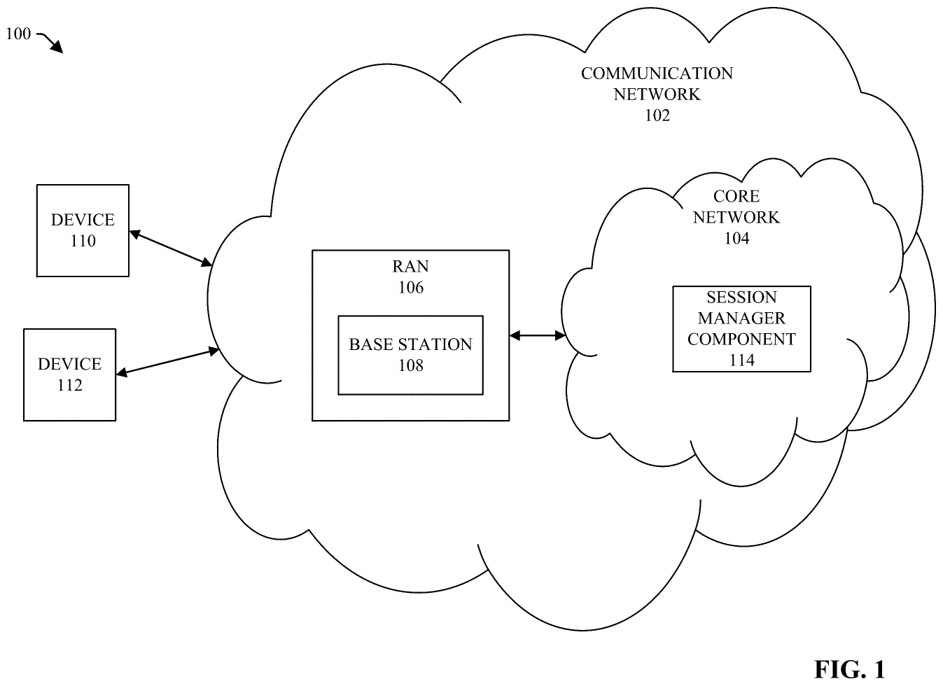

Referring now to the drawings, FIG. 1 illustrates a block diagram of a non-limiting example system 100 that can desirably (e.g., automatically, dynamically, suitably, reliably, efficiently, enhancedly, and/or optimally) manage and generate enhanced PDU sessions between a RAN and devices to facilitate exchange of data between the RAN and the devices, in accordance with various aspects and embodiments of the disclosed subject matter. The system 100 can comprise a communication network 102 that can comprise a core network 104 and one or more radio access networks (RANs), such as RAN 106, that can be associated with (e.g., communicatively connected to) the core network 104. Each RAN (e.g., RAN 106) can comprise one or more base stations, such as, for example, base station 108, that each can comprise one or more cells (not shown in FIG. 1).

The core network 104, the one or more RANs (e.g., RAN 106), the one or more base stations (e.g., base station 108), and the one or more cells can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104). The one or more RANs (e.g., RAN 106) can comprise RAN enhancements to facilitate the exchange of data, which can comprise AI-related data and/or other data, between the one or more RANs and one or more devices associated with the one or more RANs, such as described herein.

The devices can comprise, for example, devices 110 and/or 112. A device (e.g., 110 or 112) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term UE can be used to describe the device. The device (e.g., 110 or 112) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) (e.g., base station 108) can be a 5G or other NR base station (e.g., gNB or other NR-type or xG base station, wherein x can be a number greater than 5). In some embodiments, the RAN 106 can be an open RAN (O-RAN) that can be part of an O-RAN architecture and environment (e.g., the communication network 102 can employ an O-RAN architecture and environment). In accordance with various other embodiments, the RAN(s) (e.g., RAN 106) and/or the base station(s) (e.g., base station 108) can be a 4^{th} generation (4G) long term evolution (LTE) RAN or base station, or the RAN or base station can comprise 4G LTE technology and functions, and 5G or other NR-type or xG technology and functions.

The communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 110 and/or 112) and the communication network 102. The communication network 102, including the core network 104, can provide or facilitate wireless or wireline communication connections and channels between the one or more devices (e.g., devices 110 and/or 112), and/or respectively associated services or applications, and the communication network 102. For reasons of brevity or clarity, some of the various network equipment, components, functions, or devices of the communication network may not be explicitly shown or described herein.

At various times, the respective devices (e.g., devices 110 and/or 112) can utilize respective services. The services can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, AI-related service (e.g., AI, ML, neural network, or other AI-related services), real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

As disclosed, existing systems and techniques can be deficient in a number of ways. For instance, one deficiency of some existing systems and techniques can be the undesirably limited scope of distributed and federated learning, wherein distributed and federated learning can be limited to the application layer. Another deficiency of existing systems and techniques can relate to the undesirably (e.g., unsuitably, inefficiently, deficiently, or suboptimally) limiting scope of communication of data (e.g., unstructured AI-related data and/or other unstructured data) between a RAN and devices.

The disclosed subject matter can overcome these deficiencies and other problems of existing techniques. To that end, in accordance with various embodiments, the system 100 can comprise a session manager component 114 that desirably (e.g., automatically, dynamically, suitably, reliably, efficiently, enhancedly, and/or optimally) can perform and manage, or initiate or facilitate performing, establishment of PDU sessions (e.g., enhanced PDU sessions) between RANs (e.g., RAN 106) and devices (e.g., device 110 and/or device 112), in accordance with defined communication management criteria. In some embodiments, the session manager component 114 can establish (e.g., establish, or initiate or facilitate establishing) an enhanced PDU session (e.g., a RAN PDU session) between the RAN 106 and a device, such as the device 110, with a PDU session type that can have a value set to RAN (e.g., PDU session=RAN (or another value that can be representative of or can correspond to the RAN)), wherein the PDU session can terminate at the RAN 106, instead of extending to and terminating at the core network 104, and wherein there does not have to be a user plane tunnel and/or virtual tunnel (e.g., a general packet radio service (GPRS) tunneling protocol (GTP)-user plane (U) (GTP-U) tunnel) towards the UPF of the core network 104, in accordance with the defined communication management criteria. For instance, the session manager component 114 can establish the PDU session between the RAN 106 and the device 110, with a PDU session type that can have the value set to RAN, in response to receiving a request for such PDU session from the device 110. In connection with the establishment of the PDU session between the RAN 106 (e.g., the base station 108 of the RAN 106) and the device 110, the session manager component 114 (or another component of the core network 104) can establish, or initiate or facilitate establishing, a DRB between the RAN 106 and the device 110.

With the PDU session (e.g., RAN PDU session) and the DRB between the RAN 106 and the device 110 being established, the RAN 106 and the device 110, using the DRB, can communicate and exchange data with each other during the PDU session, in accordance with the defined communication management criteria. In accordance with various embodiments, the data can comprise unstructured data, AI-related data, and/or other desired data. Unstructured data can be, for example, data for which the data structure is not defined by a specification or standard (e.g., the data structure is not defined by 3^{rd} Generation Partnership Project (3GPP) specifications, or other applicable specification or standard). AI-related data can comprise, for example, AI data, AI model data, ML data, ML model data, neural network data, neural network model data, model training data, feedback information relating to AI-related models, and/or another type of AI-related data. It is to be appreciated and understood that, while some of the embodiments, aspects, and features described herein can relate to AI-related applications and services, the disclosed subject matter is not so limited, and, in accordance with other embodiments, the session manager component 114, RAN PDU sessions, and the techniques described herein can be applied to and utilized for other types of applications and services.

In some embodiments, the session manager component 114 can be part of the core network 104 (as depicted in FIG. 1). In certain embodiments, the session manager component 114 can be part of the RAN 106. In still other embodiments, the session manager component 114 can be a standalone component that can be associated with (e.g., communicatively connected to and interfaced with) the core network 104 and/or the RAN 106. In yet other embodiments, a certain portion of the session manager component 114 can be part of the core network 104, another portion of the session manager component 114 can be part of the RAN 106, and/or still another portion of the session manager component 114 can be standalone.

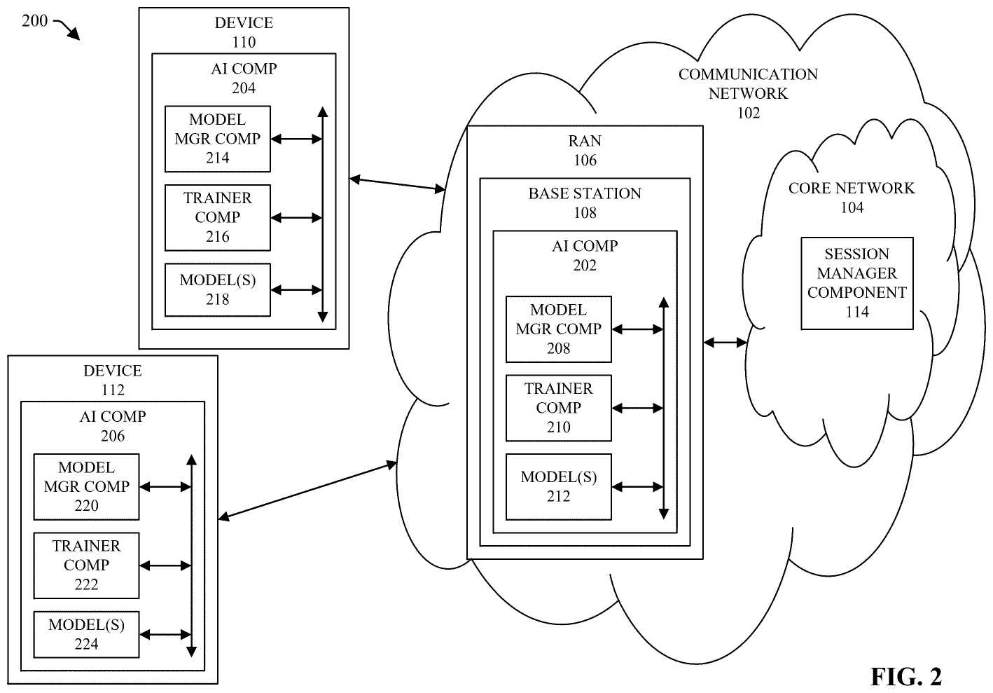

Referring to FIG. 2, FIG. 2 depicts a block diagram of a non-limiting example system 200 that can desirably (e.g., automatically, dynamically, suitably, reliably, efficiently, enhancedly, and/or optimally) employ an enhanced PDU session between the RAN and the device, and can manage and perform distributed and federated learning, using the enhanced PDU session, to facilitate training and updating (e.g., iteratively training and updating) a global AI model associated with the RAN and a local AI model associated with a device, in accordance with various aspects and embodiments of the disclosed subject matter. In some embodiments, the system 200 can be part of the system 100 as shown in FIG. 1 and described herein. The system 200 can comprise the communication network 102, the core network 104, the RAN 106, the base station 108, the device 110, the device 112, and the session manager component 114.

In accordance with various embodiments, the RAN 106 can comprise an AI component 202 (also referred to herein as global AI component 202), the device 110 can comprise an AI component 204 (also referred to herein as local AI component 204), and the device 112 can comprise an AI component 206 (also referred to herein as local AI component 206). In some embodiments, the core network 104 also can comprise an AI component (not shown in FIG. 2). The AI component 202, the AI component 204, and the AI component 206 each can comprise or employ an AI application (e.g., AI/ML application) that can facilitate performing desired AI-related operations (e.g., AI-based analysis, inferences, predictions, probabilities, determinations, and/or other operations) on data, and creating, training, and updating AI models, such as described herein. It is noted that, in some embodiments, the base station interface to the global AI component 202 (e.g., the associated AI/ML application) can be based on defined specifications or a defined model. In other embodiments, the base station interface to the global AI component 202 (e.g., the associated AI/ML application) can be a vendor specific implementation, which can be supported, in accordance with the disclosed subject matter.

The global AI component 202 can comprise a model manager component (MODEL MGR COMP) 208, a trainer component (TRAINER COMP) 210, and one or more global AI models (MODEL(S)) 212 (e.g., one or more AI, ML, neural network, and/or other AI-based models). The trainer component 210 can be employed to train or facilitate training the one or more global AI models 212 based on application (e.g., inputting) of training data (e.g., positive and/or negative training data samples, model specific data, application level data, RAN-related data, and/or other data) and/or feedback information (e.g., user feedback information and/or feedback information from another component, such as another AI component (e.g., 204 and/or 206) or another AI model) to the one or more global AI models 212. The model manager component 208 can manage (e.g., control) the exchanging of data (e.g., model specific data and/or other data) between the global AI component 202 and another component (e.g., local AI components 204 and/or 206, the base station 108, the device(s) (e.g., 110 and/or 112), and/or another component), and the application of data to the one or more global AI models 212 to facilitate the training of the one or more global AI models 212. Similarly, the local AI component 204 can comprise a model manager component 214, a trainer component 216, and one or more local AI models 218, and the local AI component 206 can comprise a model manager component 220, a trainer component 222, and one or more local AI models 224.

In some embodiments, the session manager component 114 can establish, or initiate or facilitate establishing, an enhanced PDU session (e.g., a RAN PDU session) between the RAN 106 (e.g., base station 108 of the RAN 106) and a device, such as the device 110, with the PDU session type that can have a value set to RAN, such as described herein. In certain embodiments, as part of establishing the PDU session, the session manager component 114 can provide desired QoS parameters to the base station 108 and the device 110, and the PDU session can be established based at least in part on the desired QoS parameters, in accordance with the defined communication management criteria. For example, with regard to AI-related operations and applications, the session manager component 114 can provide desirable QoS parameters (e.g., QoS parameters that can be associated with 5G QoS identifier (5QI) values associated with higher priority data traffic) to enable the PDU session and associated QoS flow(s) to have a desirably (e.g., suitably, acceptably, or optimally) high QoS that can facilitate desirable (e.g., fast, reliable, efficient, or optimal) exchange of data, comprising AI-related data, between the base station 108 (and associated global AI component 202) and the device 110 (and associated local AI component 204), such as described herein. The QoS parameters can comprise or relate to, for example, a priority level, a packet delay budget (PDB), a packet error rate (PER), a maximum data burst volume (MDBV), and/or another desired QoS parameter associated with the data traffic. In connection with establishing the PDU session, the session manager component 114 (or another component of the core network 104) can establish, or initiate or facilitate establishing, a DRB (or more than one DRB) between the RAN 106 and the device 110, such as described herein.

With the PDU session and DRB established with respect to the RAN 106 and the device 110, the base station 108, and associated global AI component 202 and global AI model, and the device 110, and associated local AI component 204 and local AI model, can utilize the PDU session (e.g., enhanced RAN PDU session) and DRB to exchange data and perform federated, distributed, and/or collaborative learning (e.g., AI-related learning by the global AI component 202 and associated global AI model, and the local AI component 204 and associated local AI model (as well as the local AI component 206 and associated local AI model associated with the device 112)). For instance, the base station 108 and the device 110 can exchange data with each other, and the global AI component 202, via the base station 108, can exchange data (e.g., unstructured AI-related data and/or other unstructured data) with the local AI component 204, via the device 110, using the DRB(s), in accordance with the defined communication management criteria.

In some embodiments, the global AI component 202 (e.g., as managed by the model manager component 208), via the base station 108, and the local AI component 204 (e.g., as managed by the model manager component 214), via the device 110, can exchange application level data (e.g., unstructured application level data), such as information relating to the data format and AI models that can be utilized by the respective AI components to facilitate creating, training, and updating the respective AI models (e.g., global AI model 212 and local AI model 218). The trainer component 216 of the local AI component 204 can train the local AI model 218 based at least in part on the application level data and/or other data (e.g., other types of training data, feedback information, device-related data, network-related data, and/or other data). For instance, the local AI model 218 can analyze (e.g., perform an AI-based analysis on) the application level data and/or the other data, and based at least in part on the results of such analysis, the local AI model 218 can be trained to generate (e.g., create) a trained local AI model 218. The training of the local AI model 218 can enable the trained local AI model 218 to generate desirable (e.g., suitable, improved, or optimal) predictions, inferences, probabilities, and/or determinations relating to the device 110 based at least in part on the results of analyzing data input to the trained local AI model 218.

The trained local AI model 218 can generate model specific data (e.g., first unstructured AI-related data) based at least in part on the training of the trained local AI model 218 and/or analysis (e.g., AI-based analysis) of subsequent data (e.g., device-related data, network-related data, and/or other data) by the trained local AI model 218. The model (e.g., local AI model) specific data can comprise AI-related data that can be specific to the device 110, the training of the trained local AI model 218, and/or the data input to the trained local AI model 218. The model specific data can relate to, for example, operations, functions, parameters, characteristics, and/or other features relating to the device 110 and/or a base station(s) (e.g., base station 108 and/or another base station), the core network 104, and/or another device(s) (e.g., device 112 and/or another device) that has interacted with (e.g., communicated with) the device 110.

As part of the PDU session, and using the DRB, the local AI component 204 (e.g., as managed by the model manager component 214), via the device 110, can communicate the model specific data to the global AI component 202 (e.g., as managed by the model manager component 208), via the base station 108. The device 110 also can generate a measurement report, comprising measurement data relating to desired communication conditions (e.g., signal quality measurements, channel quality measurements, and/or other desired measurements) associated with the device 110 (e.g., in relation to the base station 108 and/or another base station). For example, the device 110 can perform measurements relating to the desired communication conditions associated with the device 110, and can generate a measurement report that can comprise the measurement data relating to such measurements. The device 110 can communicate the measurement report to the base station 108, which can be received by the base station 108. In some embodiments, the base station 108 also can receive another measurement report(s), comprising other measurement data relating to communication conditions associated with another device(s) (e.g., device 112), from the other device.

The base station 108 can analyze the measurement data, the other measurement data, and/or other data relating to the RAN 106. Based at least in part on the results of such analysis, the base station 108 can determine and generate RAN-related data (e.g., RAN-specific data or other RAN-related data) that can relate to operations, functions, parameters, characteristics, and/or other features relating to the RAN 106. The base station 108 can communicate the RAN-related data and/or other data (e.g., some or all of the underlying data, such as the measurement data, the other measurement data, and/or other data relating to the RAN 106) to the global AI component 202.

The global AI component 202 and/or the global AI model (e.g., trained global AI model 212) can analyze (e.g., perform an AI-based analysis on) the model specific data received from the local AI component 204, the RAN-related data and/or the other data. For example, the trainer component 210 of the global AI component 202 can input (e.g., apply) the model specific data, the RAN-related data, and/or the other data to the global AI model 212. The global AI model 212 can analyze the RAN-related data and/or the other data. Based at least in part on the results of analyzing such data, the global AI model 212 can be trained or updated (e.g., training can be updated and/or refined). The training or updating of the global AI model 212 can enable the trained global AI model 212 to generate desirable (e.g., suitable, improved, or optimal) predictions, inferences, probabilities, and/or determinations relating to the RAN 106, the base station 108, and/or associated devices (e.g., device 110 and/or device 112) based at least in part on the results of analyzing data input to the trained or updated global AI model 212.

The trained or updated global AI model 212 can generate model specific data (e.g., second unstructured AI-related data) based at least in part on the training of the trained or updated global AI model 212 and/or analysis (e.g., AI-based analysis) of subsequent data (e.g., network-related data, device-related data, and/or other data) by the trained or updated global AI model 212. The model (e.g., global AI model) specific data can comprise AI-related data that can be specific to the device 110, the RAN 106, the base station 108, the training of the trained or updated global AI model 212, and/or the data input to the trained or updated global AI model 212. The model specific data can relate to, for example, operations, functions, parameters, characteristics, and/or other features relating to the device 110, the RAN 106, the base station 108, another device(s) (e.g., device 112) associated with the RAN 106, and/or the core network 104.

As part of the PDU session, and using the DRB(s), the global AI component 202 (e.g., as managed by the model manager component 208), via the base station 108, can communicate the model specific data to the local AI component 204 (e.g., as managed by the model manager component 214), via the device 110. The local AI component 204 and/or the trained local AI model 218 can analyze (e.g., perform an AI-based analysis on) the model specific data received from the global AI component 202 and/or other data (e.g., other device-related data). For example, trainer component 216 of the local AI component 204 can input (e.g., apply) the model specific data and/or the other data to the trained local AI model 218. The trained local AI model 218 can analyze the model specific data and/or the other data. Based at least in part on the results of analyzing such data, the trained local AI model 218 can be updated (e.g., training of the local AI model 218 can be updated and/or refined). The updating of the trained local AI model 218 can enable the trained local AI model 218 to generate desirable (e.g., suitable, improved, or optimal) predictions, inferences, probabilities, and/or determinations relating to the device 110, the RAN 106, and/or the base station 108 based at least in part on the results of analyzing data input to the updated local AI model 218.

In some embodiments, the updated local AI model 218 can determine, and generate as an output, one or more predictions, inferences, probabilities, and/or determinations relating to the device 110 (e.g., relating to an action that can be taken by the device 110) based at least in part on the results of analyzing data (e.g., device-related data and/or other data) input to the updated local AI model 218. The device 110 can determine a desirable (e.g., suitable, improved, or optimal) action (e.g., adjustment of a device-related parameter(s), configuration of a device function, or other action) that can be performed by the device 110, and/or can perform the desirable action, to enhance performance of the device 110 based at least in part on the one or more predictions, inferences, probabilities, and/or determinations relating to the device 110.

In certain embodiments, the trained or updated global AI model 212 can determine, and generate as an output, one or more predictions, inferences, probabilities, and/or determinations relating to the RAN 106, the base station 108, and/or the device 110 (e.g., relating to an action that can be taken by the RAN 106, the base station 108, and/or the device 110) based at least in part on the results of analyzing data (e.g., device-related data, RAN-related data, and/or other data) input to the trained or updated global AI model 212. The base station 108 can determine a desirable (e.g., suitable, improved, or optimal) action(s) (e.g., adjustment of a parameter(s), configuration of a function, handover of the device 110, or other action) that can be performed by the base station 108, the RAN 106, and/or the device 110, and/or can perform or facilitate performance of the desirable action(s), to enhance performance of the base station 108, the RAN 106, and/or the device 110 based at least in part on the one or more predictions, inferences, probabilities, and/or determinations relating to the RAN 106, the base station 108, and/or the device 110.

In some embodiments, the AI/ML infrastructure (e.g., global AI component 202 and associated AI/ML application) can be leveraged (e.g., exploited) by the devices (e.g., device 110 and/or device 112) for distributed, federated, and/or collaborative learning (e.g., AI-based learning) in processing intensive tasks and/or L1 processing tasks, including, for example, beamforming (e.g., receiver beamforming), channel estimation, scheduling of communication of data traffic, and/or other desired tasks. For instance, the global AI component 202 and associated trained global AI model 212 of the RAN 106 can be employed to train or update, or facilitate training or updating of, the local AI model 218 of the device 110 on behalf of the device 110 or in a distributed manner to facilitate enabling the local AI component 204 and associated local AI model 218 to learn, and/or to have the global AI component 202 and associated trained global AI model 212 of the RAN 106 learn on behalf of the device 110, enhancements (e.g., modifications in parameter values, modifications in configurations, and/or other modifications) that can be performed (e.g., by the device 110 or the RAN 106) with regard to beamforming, channel estimation, scheduling of communication of data traffic, and/or other desired tasks to improve performance of the device 110, the RAN 106, and/or the core network 104.

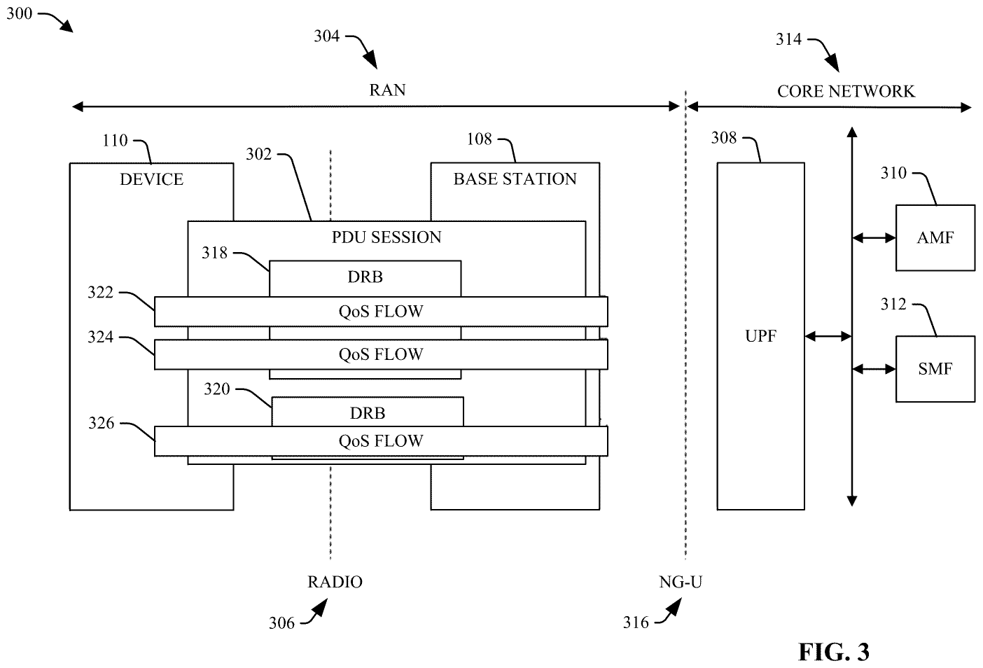

Referring to FIG. 3 (along with FIGS. 1 and 2), FIG. 3 illustrates a block diagram of a non-limiting example system 300 that can employ an enhanced PDU session (e.g., enhanced RAN PDU session) and associated QoS architecture, wherein the enhanced PDU session can desirably terminate at the RAN 106, in accordance with various aspects and embodiments of the disclosed subject matter. In some embodiments, the system 300 can be part of the system 100 as shown in FIG. 1, the system 200 as shown in FIG. 2, and/or another system, as described herein.

The example system 300 (e.g., employing the session manager component 114) can establish or create the enhanced PDU session 302, with the PDU session type set to RAN, between the RAN 106 (e.g., base station 108 of the RAN 106) and the device 110, such as described herein. The base station 108 and the device 110 can be part of the RAN region 304 (e.g., NG-RAN), wherein there can be a radio interface 306 (e.g., a wireless or cellular interface) between the base station 108 and the device 110. Network functions, such as a user plane function (UPF) 308, access and mobility management function (AMF) 310, and session management function (SMF) 312, of the core network 104 can be part of core network region 314, wherein there can be a user plane interface 316 (e.g., NG-U interface) between the RAN 106 and the core network 104. In some embodiments, the enhanced PDU session 302 can desirably (e.g., automatically, dynamically, suitably, reliably, efficiently, enhancedly, and/or optimally) facilitate distributed and federated learning, to facilitate training and updating (e.g., iteratively training and updating) of a global AI model (e.g., global AI model 212) associated with the RAN 106 and a local AI model (e.g., local AI model 218) associated with the device 110, in accordance with various aspects and embodiments of the disclosed subject matter. In other embodiments, the enhanced PDU session 302 can be utilized for other desired applications, services, or purposes.

For instance, the device 110 can communicate a request for establishment of a PDU session, with a PDU session type that can have a value that can indicate or correspond to, or can be set to, RAN, to the core network 104 (e.g., to the AMF 310 of the core network 104). With the PDU session type being the value that can indicate or correspond to, or can be set to, RAN, this can enable the SMF 312 to provide the desired QoS parameters to the device 110 without initiating a request to the UPF 308, which can be done due to the service-based interface (SBI) of the core network 104 where a service(s) offered by a network function of the core network 104 can be exposed to any network function of the core network 104 that desires (e.g., wants) to consume such service(s). The decoupling of the control and user plane of the core network 104 can separate the various procedures within the 5G or NG standards, so there may be no dependency with existing procedures.

In connection with establishing the enhanced PDU session 302, one or more DRBs, such as DRB 318 and DRB 320, can be established or created (e.g., by the base station 108) between the base station 108 and the device 110, based at least in part on QoS information (e.g., desired QoS parameters and/or other QoS-related information) that can be received from the core network 104. The DRBs 318 and 320 can be utilized to communicate (e.g., transport) data (e.g., data packets) between the base station 108 and the device 110. For instance, the DRBs 318 and 320 can be or can comprise a tunnel or channel (e.g., logical channel) that be utilized to transport data between the base station 108 and the device 110. Also, in connection with establishing the enhanced PDU session 302 and generating the associated DRBs (e.g., 318 and 320), with regard to each DRB, one or more QoS flows, such as QoS flow 322, QoS flow 324, and QoS flow 326, can be generated (e.g., by the base station 108) between the base station 108 and the device 110, based at least in part on the QoS information.

With existing PDU session types, a PDU session typically can have (e.g., can require) a user plane interface tunnel (e.g., NG-U or GTP-U tunnel) between a base station and the UPF 308, and the QoS flow(s) can extend or span through the user plane interface tunnel to the UPF 308. This can be undesirable (e.g., unwanted, inefficient, unreliable, or suboptimal), particularly with applications or services that can desire higher QoS and/or lower latency.

In some embodiments, the enhanced PDU session 302, with the PDU session type set to RAN, desirably (e.g., suitably, enhancedly, or optimally) can terminate at the RAN 106. Accordingly, the enhanced PDU session 302 desirably (e.g., suitably, enhancedly, or optimally) does not have to utilize a user plane interface tunnel (e.g., NG-U or GTP-U tunnel) between the base station 108 and the UPF 308, and the QoS flows (e.g., 322, 324, and 326) do not have to extend or span to the UPF 308 (e.g., the QoS flows can terminate at the RAN 106, like the enhanced PDU session 302). The enhanced PDU session 302 can be utilized to desirably (e.g., quickly, efficiently, reliably, or optimally) communicate data between the base station 108 and the device 110, in accordance with the desired QoS parameters (e.g., QoS parameters associated with relatively higher QoS). The system 300 (and other systems described herein), by using the enhanced PDU session 302, and terminating the PDU session in the RAN 106 (and without using a user plane interface tunnel (e.g., NG-U or GTP-U tunnel) to the core network 104 for the enhanced PDU session 302), and by enabling the transporting of unstructured data between the RAN 106 and the device 110, can enable low latency applications, including AI/ML applications, to be hosted in the RAN 106, in part, since the N3/N6 interface delay can be eliminated.

It is noted that, when the enhanced PDU session (e.g., RAN PDU session) is employed, there can be no impact to other services of the device 110, such as voice services, data services, and/or other services, since one or more of these respective other services can be in one or more respective (e.g., separate) PDU sessions that can be terminated at the UPF 308 or another UPF of the core network 104 that can be serving the respective one or more specific network slices associated with the one or more respective other services.

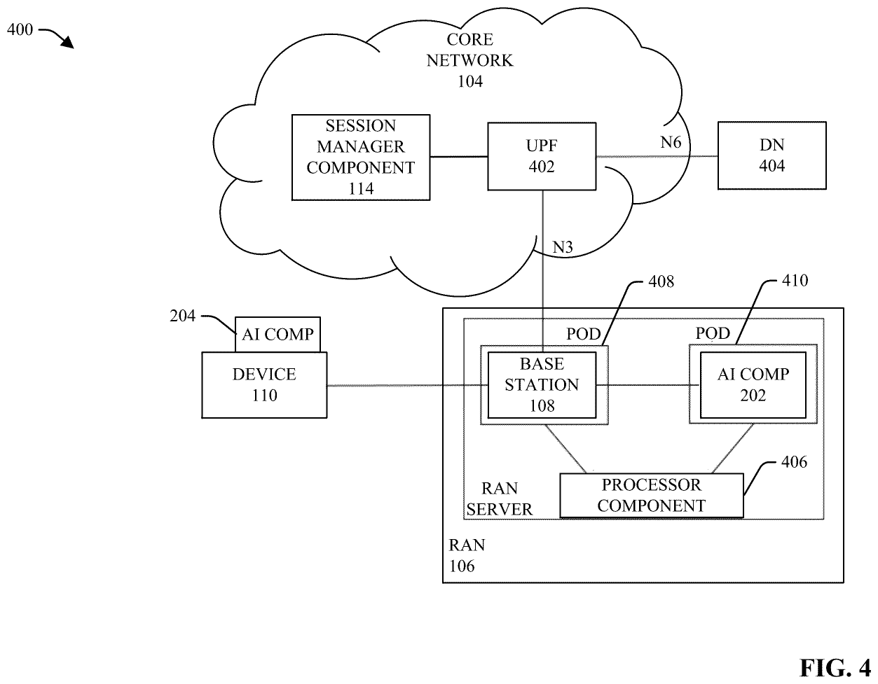

Turning to FIG. 4 (along with FIGS. 1-3), FIG. 4 depicts a block diagram of a non-limiting example system 400 that can desirably (e.g., automatically, dynamically, suitably, reliably, efficiently, enhancedly, and/or optimally) employ an enhanced PDU session (e.g., enhanced RAN PDU session) between the RAN and the device that can terminate at the RAN, to facilitate exchanging data between the RAN and the device and/or facilitate training and updating (e.g., iteratively training and updating) a global AI model associated with the RAN and a local AI model associated with a device, wherein the system 400 can operate without a UPF having to be collocated in a same local data network as the base station and the global AI component of the RAN, in accordance with various aspects and embodiments of the disclosed subject matter. In some embodiments, the system 400 can be employed as part of the system 100 as shown in FIG. 1, the system 200 as shown in FIG. 2, and/or the system 300 as shown in FIG. 3, as described herein.

The system 400 can comprise the core network 104, the RAN 106, the base station 108, the device 110, the session manager component 114, the global AI component 202, the local AI component 204, such as described herein. The core network 104 can comprise the UPF 402 and/or other network functions, such as described herein. The core network 104 (e.g., the UPF 402 and/or other network function of the core network) can be associated with (e.g., communicatively connected to) a data network (DN) 404.

The RAN 106, which can be or can comprise a RAN server node, can comprise the base station 108, the global AI component 202 (e.g., employing an AI/ML application), and a processor component 406 that can be associated with (e.g., communicatively connected to or interfaced with) each other. In some embodiments, the base station 108 can be associated with the processor component 406 via a desired interface (e.g., an L1 application programming interface (API)) to facilitate exchanging data between the base station 108 and the processor component 406, and the global AI component 202 can be associated with the processor component 406 via another desired interface (e.g., an AI/ML API) to facilitate exchanging data between the global AI component 202 and the processor component 406. In certain embodiments, the processor component 406 can comprise, for example, central processing units (CPUs), accelerators, graphics processing units (GPUs), application-specific integrated circuits (ASICs) (e.g., ASIC accelerator), and/or other type of processor equipment or function.

The base station 108 can be associated with the UPF 402 via a desired interface (e.g., an N3 interface) to facilitate exchanging data between the base station 108 and the UPF 402 (and the core network 104 more broadly). The UPF 402 (and/or other network function of the core network 104) can be associated with the DN 404 via another desired interface (e.g., an N6 interface) to facilitate exchanging data between the UPF 402 (and the core network 104 more broadly) and the DN 404.

The example system 400 (e.g., employing the session manager component 114, such as described herein) can establish or create an enhanced PDU session, with the PDU session type having a value that can correspond, indicate, or be set to RAN, between the RAN 106 (e.g., base station 108 of the RAN 106) and the device 110, using a desired signaling procedure to facilitate configuring the enhanced PDU session, such as described herein. The enhanced PDU session can terminate at the RAN 106, instead of extending or spanning to the core network 104 (e.g., the UPF 402 of the core network 104), such as described herein. This can enable the global AI component 202 (and its associated AI/ML application) to operate in the RAN 106, without having to utilize a collocated UPF that has to be collocated in the same local data network as the base station 108 and the global AI component 202 of the RAN 106 and without having to utilize a user plane interface tunnel (e.g., NG-U or GTP-U tunnel) to an external data network (e.g., the core network 104 and associated DN 404). In some embodiments, the global AI component 202 (and its associated AI/ML application) can operate in the RAN 106 in the same RAN server (as depicted) of the RAN 106 as the base station 108. The operating of the global AI component 202 in the RAN 106 can co-exist with other applications in the DN 404 for voice and other legacy packet data services.

The global AI component 202 in the RAN 106 can exchange AI-related data (e.g., AI model parameters and/or other AI-related data) with the local AI component 204 in the device 110, and also can receive RAN-related data (e.g., RAN-level measurements) from the base station 108, using, for example, radio resource control (RRC) signaling, L1 signaling, and/or other desired signaling. The GPU and/or ASIC acceleration of the processor component 406 that can be utilized by the base station 108 for L1 processing also can be leveraged by the global AI component 202 (e.g., the AI/ML application thereof) due in part to the commonality of the respective algorithms employed by the base station 108 and global AI component 202 in terms of vector processing and numerical computations.

In certain embodiments, the RAN 106 can employ pods or containers to facilitate the processing of data and the exchanging of data between various components of the RAN 106. A pod (e.g., Kubernetes pod or other type of pod), for example, can comprise one or more containers (e.g., application containers and/or other types of containers) that can have shared storage and network resources. In some embodiments, a pod 408 can be associated with and employed by the base station 108, and/or a pod 410 can be associated with and employed by the global AI component 202. In other embodiments, the RAN 106, including the base station 108, the global AI component 202, and/or the processor component 406 can operate without the use of pods.

The system 400 (and other systems described herein), by using the enhanced PDU session 302, and terminating the PDU session in the RAN 106 (and without using a user plane interface tunnel (e.g., NG-U or GTP-U tunnel) to the core network 104 for the enhanced PDU session 302), by enabling the transporting of unstructured data between the RAN 106 and the device 110, and by using accelerated processing (e.g., accelerators, GPUs, and/or ASICs) within the RAN 106, can enable low latency applications, including AI/ML applications, to be hosted in the RAN 106, in part, since the N3/N6 interface delay can be eliminated.

Also, as disclosed, the system 400 desirably (e.g., suitably, enhancedly, efficiently, and/or optimally) can operate without a UPF having to be collocated in a same local data network as the base station 108 and the global AI component 202 (and associated AI/ML application) of the RAN 106. Having the AI/ML application reside in a local data network along with the base station with a collocated UPF can have a number of drawbacks. For instance, it may not be cost effective to deploy a UPF for each base station or even a few base stations that can share the data network that hosts the AI/ML application. Also, it may not always be feasible from an orchestration and maintenance standpoint to deploy a UPF for each base station or even a few base stations that can share the data network that hosts the AI/ML application. Another drawback can be that the additional delay involved in the N3/N6 data path and processing at the UPF can undesirably hinder use cases (e.g., AI-related use cases) that can rely on fast federated learning algorithms.

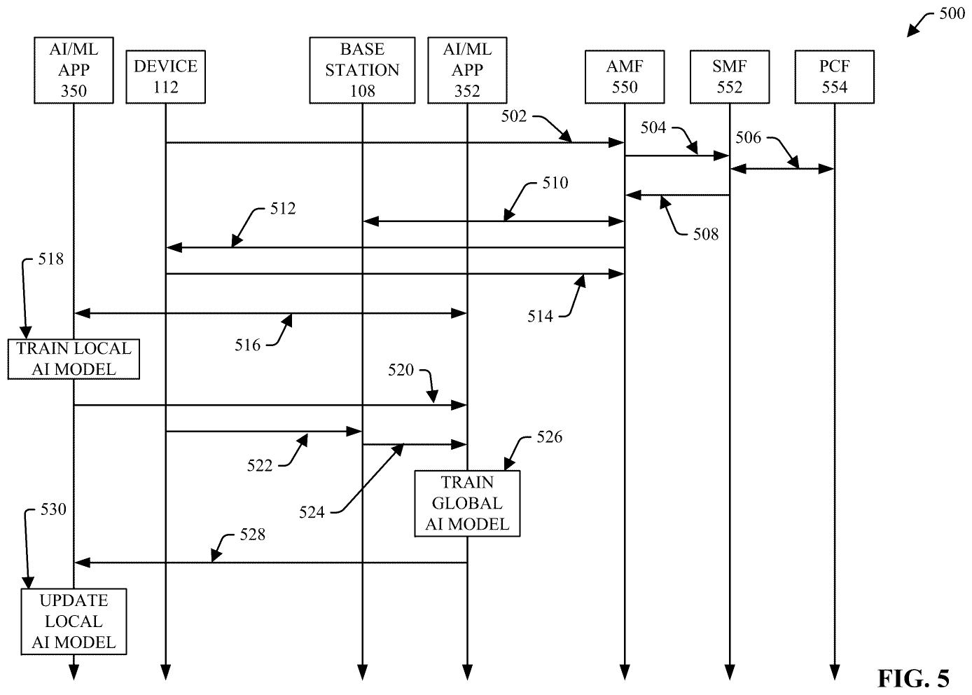

Referring to FIG. 5 (along with FIGS. 1-4), FIG. 5 depicts a diagram of a non-limiting example process flow 500 that can demonstrate example interactions of network elements in connection with performing distributed and federated learning, including the exchange of data, comprising AI-related data, between the RAN 106 and the device 110 (and associated AI components and AI/ML applications), in accordance with various aspects and embodiments of the disclosed subject matter. The process flow 500 can relate to respective interactions and communications between respective components, including the device 112, an AI component 204 (e.g., employing an AI/ML application) of or associated with the device 112, the base station 108, an AI component 202 (e.g., employing an AI/ML application) of or associated with the base station 108, the core network 104, which can comprise an AMF 550, an SMF 552, a policy control function (PCF) 354, and/or other network functions or equipment.

As indicated at reference numeral 502 of the process flow 500, the device 110 can communicate a PDU session establishment request message, with the PDU session type set to a value that can indicate RAN (e.g., PDU session type=RAN), to the AMF 350 of the core network 104. For example, if and when the AI/ML application (e.g., as employed by the AI component) of the device 110 is bootstrapped, based on device capability and operator configuration, and/or as otherwise desired by the device 110, the device 110 can initiate or trigger a PDU session establishment procedure with the PDU session type set to a value (e.g., PDU session type value) that can correspond to or be representative of RAN, and can communicate the PDU session establishment request message, with the PDU session type set to the value that can indicate RAN, to the AMF 350.

As indicated at reference numeral 504 of the process flow 500, the AMF 350 can communicate a PDU session creation request message to the SMF 352, wherein the PDU session creation request message can comprise information that can facilitate creating the PDU session, with the PDU session type set to RAN. For instance, the AMF 350 can perform SMF selection that can support this PDU session type (e.g., enhanced PDU session type set to RAN) and can forward contents of the non-access stratum (NAS) session management (SM) message.

As indicated at reference numeral 506, the SMF 352 and the PCF 354 of the core network 104 can perform a policy exchange wherein information relating to the creation of the PDU session, including desired QoS parameters relating to the PDU session (e.g., enhanced PDU session with PDU session type set to RAN), can be exchanged between the SMF 352 and the PCF 354 (e.g., the SMF 352 can receive the desired QoS parameters from the PCF 354). For instance, the SMF 352 can obtain information relating to the policy and QoS from the PCF 354, in connection with establishing the PDU session.

As indicated at reference numeral 508, the SMF 352 can communicate a PDU session creation response message, comprising the desired QoS parameters, to the AMF 350. In some embodiments, the PDU session, with the PDU session type set to RAN, can be supported using a first 5QI value (e.g., 5QI value=88), as can be defined for AI/ML applications and associated first QoS parameters, a second 5QI value (e.g., 5QI value=91), as can be defined for AI/ML applications and associated second QoS parameters (e.g., which can be different from the first QoS parameters), or another desired 5QI value that can be desirable for AI/ML applications and can be associated with other desirable QoS parameters. Non-limiting example QoS parameters for the first 5QI value (e.g., 5QI value=88) and second 5QI value (e.g., 5QI value=91), as well as other QoS parameters for other 5QI values, are presented in TABLE 1, as follows.

TABLE 1

| | | | | | Default | | |
|---|---|---|---|---|---|---|---|
| | | | | | Maximum | | |
| | | | Packet | | Data | | |
| | | Default | Delay | Packet | Burst | Default | |
| 5QI | Resource | Priority | Budget | Error | Volume | Averaging | Example |
| Value | Type | Level | (NOTE 3) | Rate | (NOTE 2) | Window | Services |
| 86 | | 18 | 5 ms | 10⁻⁴ | 1354 | 2000 | Vehicle to |
| | | | (NOTE | | bytes | ms | everything |
| | | | 5) | | | | (V2X) |
| | | | | | | | messages |
| | | | | | | | (Advanced |
| | | | | | | | Driving: |
| | | | | | | | Collision |
| | | | | | | | Avoidance, |
| | | | | | | | Platooning with |
| | | | | | | | high level of |
| | | | | | | | automation |
| | | | | | | | (LoA) |
| 87 | | 25 | 5 ms | 10⁻³ | 500 | 2000 | Interactive |
| | | | (NOTE | | bytes | ms | Service - |
| | | | 4) | | | | Motion |
| | | | | | | | tracking data |
| 88 | | 25 | 10 ms | 10⁻³ | 1125 | 2000 | Interactive |
| | | | (NOTE | | bytes | ms | Service - |
| | | | 4) | | | | Motion |
| | | | | | | | tracking data, |
| | | | | | | | split AI/ML |
| | | | | | | | inference - UL |
| | | | | | | | split AI/ML |
| | | | | | | | image |
| | | | | | | | recognition |
| 89 | | 25 | 15 ms | 10⁻⁴ | 17000 | 2000 | Visual content |
| | | | (NOTE | | bytes | ms | for |
| | | | 4) | | | | cloud/edge/split |
| | | | | | | | rendering |
| 90 | | 25 | 20 ms | 10⁻⁴ | 63000 | 2000 | Visual content |
| | | | (NOTE | | bytes | ms | for |
| | | | 4) | | | | cloud/edge/split |
| | | | | | | | rendering |
| 91 | | 25 | 5 | 10⁻⁴ | 1125 | 2000 | AI/ML |
| | | | ms | | bytes | ms | application in |
| | | | | | | | RAN |

wherein NOTE 1 can provide that a packet which is delayed more than the PDB is not counted as lost, and thus is not included in the PER; wherein NOTE 2 can provide that it can be required that a default MDBV is supported by a public land mobile network (PLMN) supporting the related 5Qis; wherein NOTE 3 can provide that certain Maximum Transfer Unit (MTU) size considerations also can be applicable, and internet protocol (IP) fragmentation may have impacts to the core network (CN) PDB; wherein NOTE 4 can provide that a static value for the CN PDB of 1 ms for the delay between a UPF terminating N6 and a 5G-access network (AN) should be subtracted from a given PDB to derive the packet delay budget that applies to the radio interface (when a dynamic CN PDB is used, the deriving of the packet delay budget that applies to the radio interface may be determined differently than the foregoing); and wherein NOTE 5 can provide that a static value for the CN PDB of 2 ms for the delay between a UPF terminating N6 and a 5G-AN should be subtracted from a given PDB to derive the packet delay budget that applies to the radio interface (when a dynamic CN PDB is used, the deriving of the packet delay budget that applies to the radio interface may be determined differently than the foregoing).

As indicated at reference numeral 510 of the process flow 500, the AMF 350 and the base station 108 can coordinate with each other, including exchanging information (e.g., the desired QoS parameters) with each other, to configure the PDU session (e.g., the enhanced RAN PDU session using the desired QoS parameters). The desired QoS parameters can be configured at the base station 108, and any vendor specific information obtained from the PCF 354, using a next generation application protocol (NGAP) private message, can be configured at the base station 108 as well.

As indicated at reference numeral 512, the AMF 350 can communicate a PDU session establishment accept message, comprising information (e.g., the desired QoS parameters) relating to the PDU session, to the device 110 to indicate that the PDU session request has been accepted and is being created, and to facilitate setting up resources for the PDU session based at least in part on the desired QoS parameters (e.g., the QoS parameters can be configured at the device 110). As indicated at reference numeral 514, the device 110 can communicate, to the AMF 350, a PDU session resource setup response message that can indicate or acknowledge that the PDU session having a PDU session type of RAN has been set up, including setting up of the resources for the PDU session, based at least in part on (e.g., in accordance with) the desired QoS parameters associated with the PDU session.

With the PDU session established, the base station 108 and the device 110 can utilize the PDU session, and associated DRB(s), to communicate AI-related data and/or other data between the base station 108 (and its associated global AI component 202 and global AI model) and the device 110 (and its associated local AI component 204 and local AI model) to facilitate desirable distributed, federated, and/or collaborative learning between the global AI component 202 (and associated global AI model) associated with the base station 108 and the local AI component 204 (and associated local AI model) associated with the device 110 to facilitate respective training and updating (e.g., iterative training and updating) of the global AI model and local AI model, such as described herein.

In that regard, as indicated at reference numeral 516 of the process flow 500, as part of the PDU session, the global AI component 202 associated with the base station 108, via the base station 108, and the local AI component 204 associated with the device 110, via the device 110, can exchange AI application level data, including information relating to the data format and the AI models. The AI application level data can facilitate creating and training of AI models.

As indicated at reference numeral 518 of the process flow 500, the local AI component 204 can train a local AI model associated with the device 110 based at least in part on the AI application level data and/or other data (e.g., other data relating to the device 110, the base station 108, the core network 104, and/or other component, device, or equipment). For instance, the local AI component 204 can create the local AI model, and can apply (e.g., input) the AI application level data and/or the other data to the local AI model, and the local AI model can analyze (e.g., perform an AI-based analysis on) the AI application level data and/or the other data to facilitate training the local AI model.

As indicated at reference numeral 520 of the process flow 500, as part of the PDU session, the local AI component 204 and/or the trained local AI model can communicate first model specific data (e.g., first unstructured AI-related data), via the device 110, to the global AI component 202, via the base station 108, using the DRB between the device 110 and the base station 108. For instance, based at least in part on the training of the trained local AI model and/or the analysis of the AI application level data, the other data, and/or subsequent data (e.g., subsequent data relating to the device 110, the base station 108, the core network 104, and/or other component, device, or equipment) by the trained local AI model, the trained local AI model can determine, and generate as an output, the first model specific data, which can be specific to the training of the trained local AI model and the data input to the trained local AI model.

As indicated at reference numeral 522 of the process flow 500, the device 110 can communicate a measurement report, comprising measurement data, to the base station 108. For instance, the device 110 can perform measurements relating to desired communication conditions (e.g., signal quality measurements, channel quality measurements, and/or other desired measurements) associated with the device 110 (e.g., in relation to the base station 108 and/or another base station). The device 110 can generate a measurement report that can comprise the measurement data relating to the measurements, and can communicate the measurement report to the base station 108. In some embodiments, the base station 108 also can receive another measurement report(s), comprising other measurement data relating to communication conditions associated with another device(s) (e.g., device 112), from the other device.

As indicated at reference numeral 524 of the process flow 500, the base station can communicate RAN-specific data to the global AI component 202. For example, the base station 108 can determine the RAN-specific data based at least in part on the measurement data of the measurement report received from the device 110, the other measurement data of the other measurement report(s) received from the other device(s), and/or other data associated with the RAN 106, and can communicate the RAN-specific data to the global AI component 202.

As indicated at reference numeral 526 of the process flow 500, the global AI component 202 can train or update the training of the global AI model based at least in part on the RAN-specific data and/or the underlying measurement data, other measurement data, and/or the other data. For instance, the global AI component 202 can apply (e.g., input) the RAN-specific data and/or the underlying measurement data, other measurement data, and/or the other data to the global AI model, and the global AI model can analyze (e.g., perform an AI-based analysis on) such data to facilitate training the global AI model. The trained global AI model can determine, and generate as an output, second model specific data, based at least in part on the training of the trained global AI model and/or the analysis of such data and/or subsequent data (e.g., subsequent data relating to the device 110, the base station 108, the core network 104, and/or other component, device, or equipment), wherein the second model specific data can be specific to the training of the trained global AI model and the data input to the trained global AI model.

As indicated at reference numeral 528 of the process flow 500, as part of the PDU session, the global AI component 202 and/or the trained global AI model can communicate the second model specific data (e.g., second unstructured AI-related data), via the base station 108, to the local AI component 204, via the device 110, using the DRB between the device 110 and the base station 108. As indicated at reference numeral 530, the local AI component 204 can update the training of the trained local AI model based at least in part on the second model specific data. For instance, the local AI component 204 can apply (e.g., input) the second model specific data and/or other data to the trained local AI model, and the trained local AI model can analyze (e.g., perform an AI-based analysis on) the second model specific data and/or the other data to facilitate updating the training of (e.g., refining) the trained local AI model.

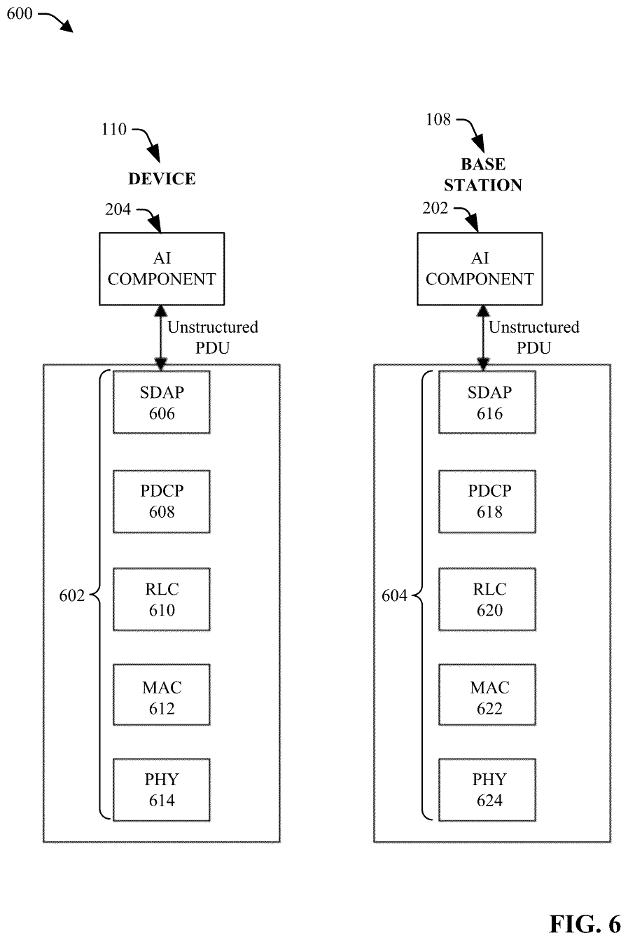

Referring to FIG. 6 (along with FIGS. 1-5), FIG. 6 illustrates a block diagram of a non-limiting example protocol stacks 600 associated with the base station 108 and the device 110 that can be utilized to facilitate the exchanging of data between the global AI component 202 (and its associated AI/ML application) and the local AI component 204 (and its associated AI/ML application) to facilitate distributed and federated learning, in accordance with various aspects and embodiments of the disclosed subject matter. The device 110 can comprise a first (e.g., device) protocol stack 602 and can comprise or be associated with the local AI component 204, and the base station 108 can comprise a second (e.g., base station or gNB) protocol stack 604 and can be associated with the global AI component 202 in the RAN 106.

The first protocol stack 602 of the device 110 can comprise, for example, a service data adaptation protocol (SDAP) layer 606 that can perform SDAP functions, a packet data convergence protocol (PDCP) layer 608 that can perform PDCP functions, a radio link control (RLC) layer 610 that can perform RLC functions, a medium access control (MAC) layer 612 that can perform MAC function, and a physical (PHY) layer 614 that can perform PHY functions. The SDAP layer 606 can coordinate or match (e.g., harmonize, pair, or link) data flows (e.g., QoS data flows) to QoS specifications (e.g., QoS requirements) and/or perform other SDAP functions. The PDCP layer 608 can encrypt messages for security, compress header information in headers (e.g., message headers) to improve efficiency, and/or perform other PDCP functions. The RLC layer 610 can correct or rectify any errors (e.g., errors in transmission of data, signals, or messages) that may occur over the air interface (e.g., air or radio interface between the device 110 and the base station 108) and/or perform other RLC functions. The MAC layer 612 can allocate radio resources for the transmission of data by the device 110 and/or perform other MAC functions. The PHY layer 614 can transmit data (e.g., from the device 110 to the base station 108) using radio signals and/or perform other PHY functions.

The second protocol stack 604 of the base station 108 similarly can comprise, for example, an SDAP layer 616 that can perform SDAP functions, a PDCP layer 618 that can perform PDCP functions, an RLC layer 620 that can perform RLC functions, a MAC layer 622 that can perform MAC function, and a PHY layer 624 that can perform PHY functions. The respective functions of the respective layers (e.g., 616, 618, 620, 622, and 624) of the second protocol stack 604 can be similar to, can correspond to, or can mirror the respective functions of the respective layers (e.g., 606, 608, 610, 612, and 614) of the first protocol stack 602.

In some embodiments, the local AI component 204 desirably (e.g., suitably, enhancedly, or optimally) can communicate unstructured data (e.g., unstructured PDU data, such as AI model specific data and/or other AI-related data) from the local AI component 204 to the SDAP layer 606 of the first protocol stack 602 of the device 110, wherein the unstructured data can be processed by the respective layers of the first protocol stack 602. As part of the PDU session (e.g., the enhanced PDU session) and using the DRB(s), the device 110 can communicate such unstructured data from the device 110 to the base station 108. The local AI component 204 also desirably can receive unstructured data that was communicated by the base station 108 (and originating from the global AI component 202 and/or associated global AI model 212) to the device 110, wherein the received unstructured data can be processed by the respective layers of the first protocol stack 602, and wherein the received unstructured data can be communicated by the SDAP layer 606 to the local AI component 204 for use and/or further processing (e.g., for training or updating of the local AI model 218) by the local AI component 204.

Similarly, the global AI component 202 desirably (e.g., suitably, enhancedly, or optimally) can communicate unstructured data (e.g., unstructured PDU data, such as AI model specific data and/or other AI-related data) from the global AI component 202 to the SDAP layer 616 of the second protocol stack 604 of the base station 108, wherein the unstructured data can be processed by the respective layers of the second protocol stack 604. As part of the PDU session and using the DRB(s), the base station 108 can communicate such unstructured data from the base station 108 to the device 110. The global AI component 202 also desirably can receive unstructured data that was communicated by the device 110 (and originating from the local AI component 204 and/or associated local AI model 218) to the base station 108, wherein the received unstructured data can be processed by the respective layers of the second protocol stack 604, and wherein the received unstructured data can be communicated by the SDAP layer 616 to the global AI component 202 for use and/or further processing (e.g., for training or updating of the global AI model 212) by the global AI component 202.

It is to be appreciated and understood that, while AI components (e.g., 202 and 204) and associated AI/ML applications are described herein as interacting with and exchanging unstructured data with the respective protocol stacks (e.g., 602 and 604) of the device 110 and base station 108, in other embodiments, other types of components and other associated types of applications and services can be employed to interact with and exchange unstructured data with the respective protocol stacks (e.g., 602 and 604) of the device 110 and base station 108.

With further regard to the second protocol stack 604 of the base station 108, it is noted that the second protocol stack 604 does not have to be modified due to, or to account for, the enhanced RAN PDU session with the definition of a PDU session type that can indicate, specify, correspond to, or be set to RAN. The SDAP layer 616 in the base station 108 can receive unstructured PDUs from the global AI component 202 (e.g., from the associated AI/ML application) that can be carried over the DRB, such as described herein. Also, any point-to-point tunneling that may be requested by the end application can be configured via the SMF-PCF interface and carried to the base station 108 in NGAP.

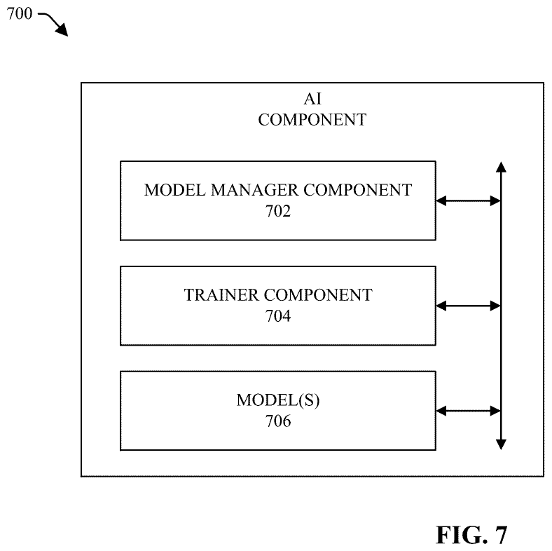

Turning to FIG. 7 (along with FIGS. 1-6), FIG. 7 depicts a block diagram of a non-limiting example AI component 700 that can perform AI-based analysis on data and generate AI-based analysis results, in accordance with various aspects and embodiments of the disclosed subject matter. In accordance with various embodiments, the example AI component 700 can be an AI component (e.g., global AI component 202) located in or associated with a base station (e.g., base station 108), an AI component (e.g., local AI component 204 or local AI component 206) located in or associated with a device (e.g., device 110 or device 112), or an AI component (e.g., another type of global AI component) located in or associated with the core network 104. The respective AI components (e.g., global AI component 202, local AI component 204, local AI component 206, or other AI component 134) can be same as, similar to, or different from each other.

The AI component 700 can comprise a model manager component 702, a trainer component 704, and a model(s) 706 (e.g., one or more trained AI-based models). The AI component 700 can perform an AI-based analysis on data, such as information relating to communication sessions, operations, functions, parameters, and/or other features associated with devices (e.g., device 110 and/or device 112), the RAN(s) 106, and/or the core network 104, information relating to models 706, including AI-related data received from another device or component (e.g., as part of the enhanced PDU session), and/or feedback information (e.g., feedback information from a user, a device, a base station, network equipment or network function of the core network 104, or another data source). In some embodiments, with regard to a model 706, the AI component 700 (e.g., the trainer component 704, as managed by the model manager component 702) can input such information into the (trained) model 706 for analysis by the model 706 to train or update the model 706 and/or to generate output results (e.g., AI-related data) based at least in part on the analysis of the input information.

In connection with or as part of such an AI-based analysis, the AI component 700 can employ, build (e.g., construct or create), and/or import, AI-based techniques and algorithms, AI models 706 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about relationships between components (e.g., base stations, cells, network nodes, communication links, devices, or other components or functions) of or associated with the communication network 102, determining or learning about data traffic associated with a communication session between a base station and a device, determining a group of parameters associated with a device, a base station, or network equipment or a network function of the core network 104, determining a configuration or a group of settings of a device, a base station, or network equipment or a network function of the core network 104, determining QoS associated with data traffic, performing other desired functions or operations, and/or automating one or more functions or features of the disclosed subject matter, as more fully described herein.

The AI component 700 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 700 can examine the entirety or a subset of the data (e.g., the training data; the operational data relating to the communication network 102, the core network 104, a device (e.g., device 110 and/or device 112), a RAN (e.g., the RAN 106), a base station (e.g., base station 108), and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 700 and/or the trained model(s) 706 can employ one or more threshold probabilities (e.g., threshold probability values) to facilitate making a determination. For instance, in making a determination (e.g., relating to data traffic, operations of a device, operations of a base station, operations of a RAN, operations of network equipment or network function of the core network 104, the group of parameters, the configuration or the group of settings, QoS, or other element or function), as part of the AI-based analysis of information, the AI component 700 and/or the trained model(s) 706 can determine a probability (e.g., a probability of performance enhancement relating to data traffic, operations of a device, operations of a base station, operations of a RAN, operations of network equipment or network function of the core network 104, the group of parameters, or other element, function, feature, or characteristic associated with a device, base station, RAN, or core network), and can determine whether the probability (e.g., probability value) satisfies (e.g., meets or exceeds; or is at or greater than) a defined and applicable threshold probability. The AI component 700 and/or the trained model(s) 706 can make a determination (or prediction or inference) (e.g., relating to data traffic, operations of a device, operations of a base station, operations of a RAN, operations of network equipment or network function of the core network 104, the group of parameters, or other element, function, feature, or characteristic associated with a device, base station, RAN, or core network) based at least in part on the results of analyzing (e.g., comparing) the probability to the defined and applicable threshold probability (e.g., threshold minimum probability value). As a non-limiting example, the AI component 700 (e.g., global AI component 128 of the RAN 106) and/or the trained model(s) 706 (e.g., trained global AI model of the RAN 106) can make a determination (or prediction or inference) that a particular group of parameters employed by the device 110 in a particular scenario involving a certain set of conditions can be employed by another device (e.g., device 112) in a same or similar scenario involving the same or similar set of conditions to enhance performance associated with the other device (e.g., device 112) and/or the RAN 106 based at least in part on determining that a probability relating to (e.g., indicating) whether the particular group of parameters can enhance performance of the other device (e.g., device 112) satisfies (e.g., meets or exceeds; or is at or greater than) the defined and applicable threshold probability (e.g., the probability is the highest probability, relative to other probabilities associated with other groups of parameters, and satisfies the defined and applicable threshold probability). In some embodiments, such determination (or prediction or inference) can be made by the AI component 700 and/or the trained model(s) 706 without utilizing the defined and applicable threshold probability (e.g., the AI component 700 and/or the trained model(s) 706 can perform such determination (or prediction or inference) based at least in part on the probability being determined to be the highest probability, as compared to other probabilities associated with other groups of parameters).

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 700 can employ a classifier that can perform an AI-based analysis on data. A classifier can map an input attribute vector, z=(z1, z2, z3, z4, . . . , zn), to a confidence that the input belongs to a class, as by f (z)=confidence (class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In certain embodiments, the AI component 700 (e.g., employing the trainer component 704, as managed by the model manager component 702) can comprise, generate, and/or train AI models 706 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between components (e.g., base stations, cells, network nodes, communication links, devices, or other components or functions) of or associated with the communication network 102; data traffic (e.g., type of data traffic, amount of data traffic, or other characteristic of data traffic) associated with a communication session between a base station and a device; a group of parameters associated with a device, a base station, or network equipment or a network function of the core network 104 that can enhance performance of the device, base station, or network equipment or network function of the core network 104; a configuration or a group of settings of a device, a base station, or network equipment or a network function of the core network 104 that can enhance performance of the device, base station, or network equipment or network function of the core network 104; and/or an effect on performance, QoS, and/or power consumption as a result of modification of parameters, configuration, or settings; and/or to perform other desired functions or operations, and/or to automate one or more functions or features of the disclosed subject matter, as described herein.

For instance, the AI component 700 can employ the trainer component 704 (e.g., as managed by the model manager component 702) to train (or refine or update training of) a (trained) AI model(s) 706 to perform such learning, determinations, predictions, or inferences, and/or perform such other desired functions or operations, and/or automate such functions of features, based at least in part on application of training data (e.g., model specific data, positive or negative training data samples, and/or other AI-related data) and/or feedback information to the (trained) AI model 706, wherein the training data and/or feedback information can comprise or relate to, for example, current or previous communication sessions associated with a device(s), services, data traffic associated with devices, parameters, configuration, or settings associated with the device(s), a base station(s), or network equipment or a network function(s) of the core network 104, the defined communication management criteria, threshold values, and/or other data. Such training of the trained AI model(s) 706 can enable the trained AI model(s) 706 to perform an AI-based analysis on information relating to a device(s), a base station(s), a RAN(s), network equipment or a network function(s) of the core network 104, wherein, based at least in part on the results of such AI-based analysis, the trained AI model(s) 706 can learn, determine, predict, or infer data patterns in data; a correlation, relationship, or causation between an item(s) of data and another item(s) of data; a correlation, relationship, or causation between an event and another event (e.g., occurrence of another event); relationships between components (e.g., base stations, cells, network nodes, communication links, devices, or other components or functions) of or associated with the communication network 102; data traffic (e.g., type of data traffic, amount of data traffic, or other characteristic of data traffic) associated with a communication session between a base station and a device; a group of parameters associated with a device, a base station, or network equipment or a network function of the core network 104 that can enhance performance of the device, base station, or network equipment or network function of the core network 104; a configuration or a group of settings of a device, a base station, or network equipment or a network function of the core network 104 that can enhance performance of the device, base station, or network equipment or network function of the core network 104; and/or an effect on performance, QoS, and/or power consumption as a result of modification of the parameters, the configuration, or the settings; and/or to perform other desired functions or operations, and/or to automate one or more functions or features of the disclosed subject matter.

In some embodiments, the AI component 700 (e.g., employing the trainer component 704 and model manager component 702) can update (e.g., modify, adjust, refine, or change), and further train and enhance, the trained AI model(s) 706 as additional data (e.g., information relating to further operation of, or modifications or changes to, the communication network 102, core network 104, RAN 106, base stations (e.g., base station 108), cells, devices (e.g., devices 110 and/or 112), parameters, configurations, settings, data traffic, QoS associated with data traffic, power consumption associated with a device, RAN 106, base station, core network 104, or the communication network 102, services, and/or other functions, features, or operations; output results (e.g., AI-based analysis results) output from the AI model(s) 706 associated with an entity (e.g., a device, a base station, a RAN, or the core network 104) and/or output results output from another AI model(s) associated with another entity (e.g., another of a device, a base station, a RAN, or the core network 104); the feedback information; and/or other information) is received and analyzed by the AI component 700 or trained AI model(s) 706. In some embodiments, as part of the data analysis, and the determining and training of the AI models 706, the AI component 700 can employ (and/or train) Markov chains, a neural network(s), decision trees, or other AI-based modeling, techniques, functions, or algorithms.

In some embodiments, to facilitate desirable distributed, federated, and/or collaborative learning, the devices (e.g., device 110 and/or device 112) and the RAN 106 (e.g., the base station 108 of the RAN 106) can employ enhanced PDU sessions, with the PDU session type having a value that can correspond to, can indicate, or can be set to RAN, wherein, as part of the enhanced PDU sessions, unstructured data, including AI-related data generated by the respective AI components (e.g., 202, 204, and/or 206) and respective AI models, can be communicated or exchanged between the devices and the RAN 106, such as described herein. For instance, the local AI component 204 and/or associated trained local AI model 218 associated with the device 110 can generate first AI-related data relating to operation of the device 110, the RAN 106, and/or the core network 104, and the local AI component 206 and/or associated trained local AI model 224 associated with the device 112 can generate second AI-related data relating to operation of the device 112, the RAN 106, and/or the core network 104. As part of respective enhanced PDU sessions, the base station 108 can receive the first AI-related data from the device 110 and the second AI-related data from the device 112.

The base station 108 can employ the global AI component 202 to input the first AI-related data, the second AI-related data, and/or other data to the global AI model 212 to train or update the global AI model 212. The global AI model 212 can analyze (e.g., perform an AI-based analysis on) the first AI-related data, the second AI-related data, and/or the other data. Based at least in part on the results of such analysis, the global AI model 212 can be trained or updated, and/or can render and output predictions, inferences, probabilities, determinations, or decisions relating to operations, functions, parameters, and/or features of the base station 108 (or another base station), one or more devices (e.g., device 110 and/or device 112), and/or the core network 104. As a non-limiting example, based at least in part on the analysis results, the global AI model 212 can generate or determine a prediction or inference relating to location (e.g., a predicted future location at a future time), mobility (e.g., predicted mobility), or trajectory (e.g., predicted trajectory) of the device 110. The base station 108 can determine a desired first action (e.g., modify a parameter(s) of the base station 108 and/or device 110, handover the device 110 to another base station, communicate information or instructions relating to a desired second action to the device 110, or another action) to perform, and/or the desired second action (e.g., modify a parameter(s) of the device 110, facilitate handover of the device 110 to the other base station, or another action) for the device 110 to perform, based at least in part on the prediction or inference relating to the location, mobility, or trajectory of the device 110. The base station 108 can perform the first action with respect to the device 110 and/or can communicate information or instructions relating to the second action to the device 110 to have the device 110 perform the second action.

As another non-limiting example, the device 110 can at least indirectly (e.g., via the base station 108 and/or the core network 104) communicate AI-related data to the device 112, or vice versa. For instance, as part of a first enhanced PDU session, the device 110 can communicate first AI-related data (e.g., generated by the local AI component 204 and/or the trained local AI model 218) to the base station 108. The first AI-related data can relate to, for example, a group of parameters (e.g., group of parameter values) that can be desirable to utilize under a certain set of conditions. As part of a second enhanced PDU session, the base station 108 can communicate the first AI-related data to the device 112 and/or the associated local AI component 206. The local AI component 206 and/or the trained local AI model 224 associated with the device 110 can process and/or analyze the first AI-related data (e.g., to update the local trained local AI model 224, and/or have such AI model render a prediction or inference relating to the device 112, based at least in part on the results of analyzing the first AI-related data). Based at least in part on such prediction or inference, the device 112 can perform a desired action. For example, under conditions that are same as or similar to the certain set of conditions, the trained or updated local AI model 224 can determine, predict, or infer that it can be desirable for the device 112 to utilize the group of parameters, or to utilize an adapted group of parameters (e.g., as determined by the trained or updated local AI model 224 based at least in part on such analysis results), under such same or similar conditions. The device 112 can perform the desired action to utilize the group of parameters or the adapted group of parameters when the device 112 is subjected to such same or similar conditions.

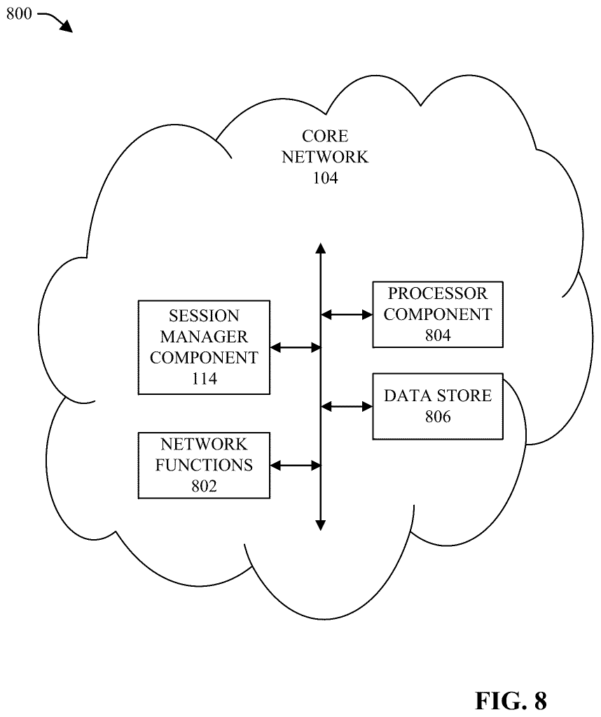

Turning to FIG. 8 (along with FIGS. 1-7), FIG. 8 illustrates a block diagram of a non-limiting example system 800 that can desirably (e.g., automatically, dynamically, suitably, reliably, efficiently, enhancedly, and/or optimally) manage, facilitate performing, and/or facilitate initiating or establishing enhanced PDU sessions (e.g., enhanced RAN PDU sessions) between the RAN and devices to facilitate distributed and federated learning, in accordance with various aspects and embodiments of the disclosed subject matter. The system 800 can comprise the core network 104, the session manager component 114, and network functions 802, which can comprise the respective functionality and features described herein. In some embodiments, the system 800 can be part of the system 100 depicted in FIG. 1, the system 200 depicted in FIG. 2, and/or other system described herein.

The network functions 802 can comprise, for example, the UPF, AMF, SMF, PCF, application function (AF), an unstructured data storage function (UDSF), a network data analytics function (NWDAF), a network exposure function (NEF)/AF, a time sensitive networking AF (TSNAF)/time sensitive communication and time synchronization function (TSCTSF), and/or another network function (not explicitly shown in FIG. 8 for reasons of brevity and clarity). In certain embodiments, the UPF (which also can be referred to as a UPF node) can connect to or interface with the one or more RANs (e.g., RAN 106) and the one or more base stations (e.g., base station 108), can be an interconnect point between the core network 104 and a data network (e.g., DN 404), can provide or facilitate providing a PDU session anchor point for providing mobility associated with radio access technologies (RATs), can provide or facilitate providing data packet routing or forwarding, and/or can perform or manage other functions.

The AMF node can be a control plane function that can manage registration and deregistration of devices (e.g., devices 110 and/or 112) with the core network 104, manage connections of devices with the core network 104, manage mobility associated with devices (e.g., maintain knowledge of locations of devices, update locations of devices), and/or manage or perform other functions. The SMF can be part of the control plane of the core network 104, and can generate, update, or remove PDU sessions, manage session context with the UPF, selection and management of UPFs, UE network (e.g., IP) address allocation, and/or perform other functions.

The PCF can enable desirable policy control and management, and can facilitate network behavior control, network slicing, device activities, and communication with other network functions. The PCF can act or operate as control plane network function that can be responsible for managing and/or enforcing policies that can regulate various aspects and features of the core network 104, wherein the policies can relate to or involve, for example, QoS, network resource allocation, authentication, mobility, security, and/or other aspects and features.

The AF, which can be a control plane function, can be associated with, and can act as or fulfill all or part of the role of, the application server, and can interact and communicate with other network functions, including control plane functions, of the core network 104. The AF and associated application server can facilitate (e.g., enable) provision of various services (e.g., voice services, messaging services, media streaming services, Internet and intranet services, multimedia conferencing and collaboration services, or other services) and applications to devices associated with the core network 104. Some of the services can be low latency services and/or network edge services. The AF can comprise one or more AFs that respectively can be owned or managed by the network operator of the core network 104 or by third parties (e.g., trusted third parties). In some embodiments, the UPF can be associated with, and can interact and communicate with, the AF and/or other network functions (e.g., other control plane functions) via an SBI.

The UDSF can be part of the control plane of the core network 104, and can be used as primary or secondary storage for storing data, which can comprise unstructured data (e.g., unstructured PDUs, which can include AI-related data), dynamic state data (e.g., UE context data or other UE-related data), data (e.g., session data) for stateless network functions, and/or other unstructured data

The NWDAF can be part of the control plane of the core network 104, and can perform an AI-based analysis (e.g., an AI/ML analysis) on data, can employ AI models (e.g., trained global AI, ML, or neural network models), and can perform predictive analytics on data for the core network 104. In accordance with various embodiments, the NWDAF can be, can be part of, or can comprise an AI component of the core network 104, and/or can be an AI/ML host, and/or can employ an AI/ML application to facilitate performing AI-based analysis and functions, such as described herein. It is noted that, in certain embodiments, additionally or alternatively, the AF can comprise an AI component for the core network 104, and/or can be an AI/ML host, and/or can employ an AI/ML application to facilitate performing AI-based analysis and functions, such as described herein. The NWDAF can collect, consume, and analyze various data (e.g., statistics, metrics, event data relating to events, UE-related data, RAN-related data, core network-related data, and/or other data) from network functions of the core network 104, the RAN 106, UEs (e.g., device 110 and/or device 112), and/or other components or data sources, can perform network function discovery and identification, can generate and train (e.g., iteratively train) AI models (e.g., AI models, ML models, neural network models, or other AI-based models) based at least in part on the results of performing AI-based analysis on the various data, perform or facilitate performing core network optimization, cost optimization, and resource management optimization for the core network 104, and/or perform other AI-based functions.

The respective network functions can be associated with each other via respective interfaces (e.g., Nupf, Naf, Namf, Nsmf, Nudsf, Nnwdaf, and/or other network interfaces). The UPF can be associated with (e.g., communicatively connected to or interfaced with) the RAN 106 via the N3 interface, and the AMF can be associated with (e.g., communicatively connected to or interfaced with) the RAN 106 via an N2 interface. In some embodiments, the AMF also can be associated with (e.g., communicatively connected to or interfaced with) a device (e.g., device 110 or device 112) via an N1 interface.

As disclosed, the core network 104 can comprise an SBI from the UPF to the AF and various other network functions (e.g., SMF, PCF, NWDAF, NEF/AF, TSNAF/TSCTSF, and/or other network functions) of the core network 104. Based at least in part on operator (e.g., core network operator) policy, the core network 104 can share data with third-party applications in the AF through the SBI.

In accordance with various embodiments, the session manager component 114 can be a separate component from other network functions or can be part of one or more of the other network functions (e.g., AMF, SMF, PCF, and/or other network function) of the core network 104.

In accordance with various embodiments, the system 800 can comprise a processor component 804 that can be associated with (e.g., communicatively connected to) and can work in conjunction with other components of the system 800, including the session manager component 114, the network functions 802, the AI component, a data store 806, and/or other components of the system 800, to facilitate performing the various functions and operations of the system 800. The processor component 804 can employ one or more processors (e.g., one or more CPUs, accelerators, GPUs, ASICs, microprocessors, or controllers that can process information relating to data, files, services, applications, communication network, core network, RANs, cells, devices, users, resources, communication sessions (e.g., PDU or other communication sessions), PDU session types, performance indicators, UE protocol layers, application layer, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), downlink control information (DCI), congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced PDU session generation algorithms, enhanced data exchange algorithms, enhanced distributed, federated, and collaborative algorithms, AI algorithms, hash algorithms, data compression algorithms, data decompression algorithms, and/or other algorithm), interfaces, protocols, tools, and/or other information, to facilitate operation of the system 800, and control data flow between the system 800 and/or other components (e.g., network equipment or components, the RAN 106 or another RAN, a base station (e.g., base station 108) of the RAN(s), the communication network 102, a device (e.g., 110 or 112), a node, an application, a service, a user, or other entity) associated with the system 800.

The data store 806 can store data structures (e.g., user data, metadata), code structure(s) (e.g., modules, objects, hashes, classes, procedures) or instructions, information relating to data, files, services, applications, communication network, core network, RANs, cells, devices, users, resources, communication sessions, PDU session types, performance indicators, UE protocol layers, application layer, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced PDU session generation algorithms, enhanced data exchange algorithms, enhanced distributed, federated, and collaborative algorithms, AI algorithms, hash algorithms, data compression algorithms, data decompression algorithms, and/or other algorithm), interfaces, protocols, tools, and/or other information, to facilitate controlling or performing operations associated with the system 800. The data store 806 can comprise volatile and/or non-volatile memory, such as described herein. In an aspect, the processor component 804 can be functionally coupled (e.g., through a memory bus) to the data store 806 in order to store and retrieve information desired to operate and/or confer functionality, at least in part, to the session manager component 114, the network functions 802, the AI component, the processor component 804, the data store 806, and/or other component of the system 800, and/or substantially any other operational aspects of system 800.

As disclosed, the data store 806 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

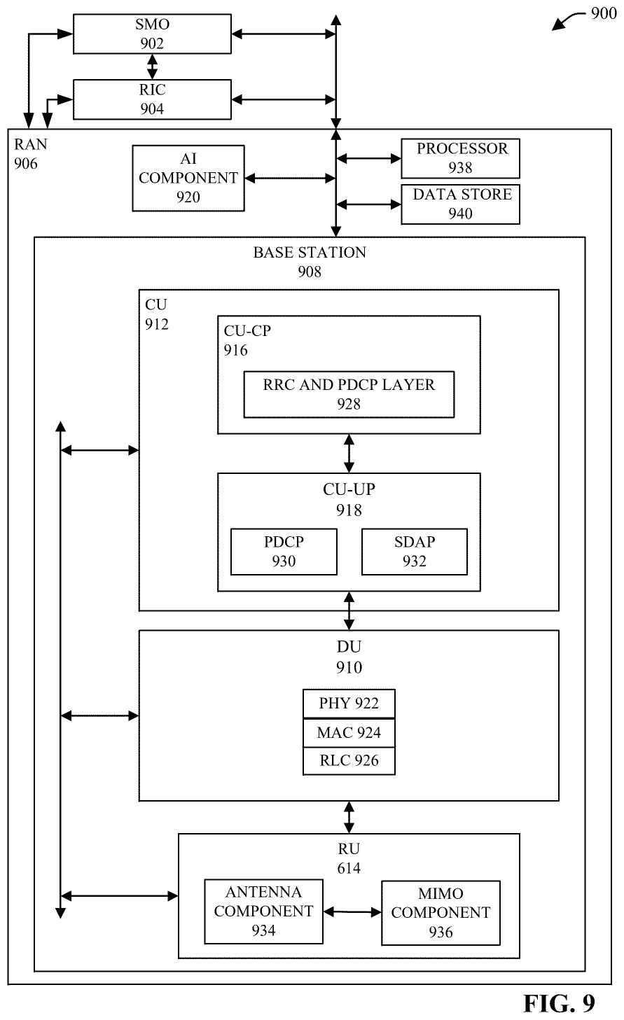

Turning to FIG. 9 (along with FIGS. 1-7), FIG. 9 depicts a block diagram of non-limiting example system 900 that can employ enhanced PDU sessions between a device and a base station in an O-RAN communication network environment to facilitate desirable (e.g., suitable, reliable, efficient, enhanced, and/or optimal) management and performance of distributed and federated learning to facilitate training and updating a global AI model of a base station of the RAN(s) and local AI models of devices associated with the RAN(s), in accordance with various aspects and embodiments of the disclosed subject matter. In some embodiments, the system 900 can be part of the system 100 depicted in FIG. 1, the system 200 depicted in FIG. 2, or another system described herein.

The system 900 can comprise a service management and orchestration (SMO) 902, a RIC 904, and a RAN 906. In some embodiments, the RAN 906 can be an O-RAN that can be part of an O-RAN architecture and environment (e.g., the communication network 102 can employ an O-RAN architecture and environment). In certain embodiments, the RAN 906 can be a cloud-based or centralized RAN (C-RAN) that can be part of a cloud or centralized RAN (C-RAN), or a virtual RAN (vRAN) that can be part of a vRAN architecture and environment (e.g., the communication network 102 can employ a C-RAN or vRAN architecture and environment). In still other embodiments, the RAN 906 may not be an O-RAN, C-RAN, or vRAN.

In accordance with various embodiments, the RAN 906 and associated communication network (e.g., communication network 102) can be part of a 5G or other new radio (NR) communication environment (e.g., an xG communication environment, wherein x can be 5 or a number greater than 5). With regard to 5G or other NR generation, the RAN 906 can comprise base stations, such as a gNodeB (gNB or NR-NB), that can be disaggregated into a central unit (CU) (e.g., gNB or other NR-NB CU), comprising a CU-user plane (CU-UP) (e.g., gNB or other NR-NB CU-UP), a CU-control plane (CU-CP) (e.g., gNB or other NR-NB CU-CP), a distributed unit (DU) (e.g., gNB or other NR-NB DU), a radio unit (RU) (e.g., a gNB or other NR-NB RU), and/or other components. The CU-UP and DU can be part of the user plane node, with the CU-UP hosting PDCP and SDAP entities, and the DU can host the RLC, MAC, and PHY layers. For instance, the RAN 906 can comprise the base station 908 that can comprise a DU 910, a CU 912, and an RU 914. The CU 912 can comprise a CU-CP 916 (which also can be referred to as a CU-CP node) and a CU-UP 918 (which also can be referred to as a CU-UP node). In certain embodiments, the RAN 906 and/or the base station 908 can comprise multiple DUs, multiple CU-CPs, multiple CU-UPs, and/or multiple RUs. In some embodiments, the DU 910, the CU 912, and the RU 914 can be co-located at a cell site. In other embodiments, one or more of the components (e.g., the CU 912, or at least part of the CU 912, such as the CU-CP 916) of the base station 908 can be located in different location than one or more other components (e.g., DU 910, RU 914, and/or CU-UP 918) of the base station 908.

In accordance with various embodiments, the system 900 can comprise the AI component 920 that can be associated with (e.g., communicatively connected to or part of) the DU 910, the CU 912, the RU 914, or another component of or associated with the base station 908. In certain embodiments, the AI component 920 can be a separate component in the RAN 906 (as depicted in FIG. 9) or base station 908, and can be associated with the DU 910 and/or one or more of the other components of the RAN 906 or base station 908. In other embodiments, the AI component 920 can be part of the DU 910. In still other embodiments, the AI component 920 can be part of another component of or associated with the RAN 906 or base station 908. The AI component 920 can comprise various components and functions, and can perform various operations, such as described herein.

In some embodiments, the base station 908 can be a split base station (e.g., split gNB), wherein some of the components of the base station 908 can be located in a first location, and other components of the base station 908 can be located in a second location. In such embodiments, the CU-UP 918 (e.g., CU-UP function) can be in the data path to the global AI component 920 (e.g., to the associated AI/ML application), and thus, it can be desirable (e.g., wanted) to have the CU-UP 918 reside along with the DU 910 in the same location if it is desired for the computing resources or other resources to be shared by the CU-UP 918, the DU 910, and/or the global AI component 920.

The DU 910 can be a logical node that can host or handle baseband (e.g., PHY layer) 922 and layer 2 (L2) (e.g., a MAC layer 924 and a RLC layer 926) functionality associated with the base station 908. The CU-CP 916 can be a logical node that can host or handle layer 3 (L3) (e.g., a RRC and PDCP layer 928) control plane functionality associated with the base station 908. The CU-UP 918 can be a logical node that can host or handle data traffic between the core network 104 (e.g., 5G core network) and one or more DUs (e.g., the DU 910) to which the CU-UP 918 is connected. In some embodiments, the CU-UP 918 can comprise a PDCP layer 930 that can perform PDCP functions, and an SDAP layer 932 that can perform SDAP functions, such as described herein.

The RU 914 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 906 and other devices (e.g., devices 110 and/or 112) or components (e.g., components or functions of the core network 104 or communication network 102). In some embodiments, the RU 914 can comprise an antenna component 934 that can comprise an antenna array that can comprise a desired number of transmitter and receiver antennas to facilitate transmission and receiving of signals comprising information, and perform various beamforming, antenna-related, and communication-related functions. The RU 914 also can comprise a multiple input, multiple output (MIMO) component 936 that can be employed to generate or modify a number of MIMO spatial layers and a number of spatial streams employed by the base station 908 (e.g., with regard to a device(s)) during a communication session between the base station 008 and a device (e.g., device 110), and perform MIMO spatial multiplexing functions. In certain embodiments, the MIMO component 936 can be configured in a single user (SU)-type MIMO mode or a multiple user (MU)-type MIMO mode. In some embodiments, the MIMO component 936 can employ or support massive MIMO (mMIMO). The RU 914 also can comprise or be associated with other functions, including, for example, modulation and coding scheme (MCS) functions and transmit diversity functions.

In some embodiments, as disclosed, the system 900 can comprise an O-RAN architecture and environment, and the RAN 906 can be an O-RAN. In some embodiments, in the O-RAN architecture and environment, the SMO component 902 can be associated with (e.g., communicatively connected to) the RIC 904 and/or the RAN 906 (and/or one or more other RANs) via an interface(s) (e.g., an O1 interface, an A1 interface, or another interface), to facilitate communication of information between the SMO component 902 and the RIC 904 and/or the RAN 906 (and/or one or more other RANs), and the RIC 904 can be associated with the RAN 906 (and/or one or more other RANs) via an interface(s) (e.g., an E2 interface or another interface), to facilitate communication of information between the RIC 904 and the RAN 906 (and/or one or more other RANs).

The SMO component 902 can act and operate as a management and orchestration layer that can control configuration and automation aspects of the RIC 904 and RAN elements of the RAN(s) 906. The SMO component 902 can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time.

The RIC 904 can operate to control (e.g., manage) and enhance (e.g., improve or optimize) RAN functions and services of the RAN(s) 906. At least some of the various network functions and components of the RIC 904 can operate in real time or near real time, and some network functions and components of the RIC 904 may operate in non-real time.

In accordance with various embodiments, the system 900 can comprise a processor component 938 that can be associated with (e.g., communicatively connected to) and can work in conjunction with other components of the system 900, including the SMO component 902, the RIC 904, the RAN 906, the AI component 920, a data store 940, and/or other components of the system 900, to facilitate performing the various functions and operations of the system 900. The processor component 938 can employ one or more processors (e.g., one or more CPUs, accelerators, GPUs, ASICs, or other processors), microprocessors, or controllers that can process information relating to data, files, services, applications, communication network, core network, RANs, cells, devices, users, resources, communication sessions, PDU session types, performance indicators, UE protocol layers, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced PDU session generation algorithms, enhanced data exchange algorithms, enhanced distributed, federated, and collaborative algorithms, AI algorithms, hash algorithms, data compression algorithms, data decompression algorithms, and/or other algorithm), interfaces, protocols, tools, and/or other information, to facilitate operation of the system 900, and control data flow between the system 900 and/or other components (e.g., network equipment, components, or functions, the communication network 102, the core network 104, another base station, a device (e.g., 110 or 112), a node, an application, a service, a user, or other entity) associated with the system 900.

The data store 940 can store data structures (e.g., user data, metadata), code structure(s) (e.g., modules, objects, hashes, classes, procedures) or instructions, information relating to data, files, services, applications, communication network, core network, RANs, cells, devices, users, resources, communication sessions, PDU session types, performance indicators, UE protocol layers, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced PDU session generation algorithms, enhanced data exchange algorithms, enhanced distributed, federated, and collaborative algorithms, AI algorithms, hash algorithms, data compression algorithms, data decompression algorithms, and/or other algorithm), interfaces, protocols, tools, and/or other information, to facilitate controlling or performing operations associated with the system 900. The data store 940 can comprise volatile and/or non-volatile memory, such as described herein. In an aspect, the processor component 938 can be functionally coupled (e.g., through a memory bus) to the data store 940 in order to store and retrieve information desired to operate and/or confer functionality, at least in part, to the SMO component 902, the RIC 904, the RAN 906, the AI component 920, the processor component 938, the data store 940, and/or other component of the system 900, and/or substantially any other operational aspects of system 900.

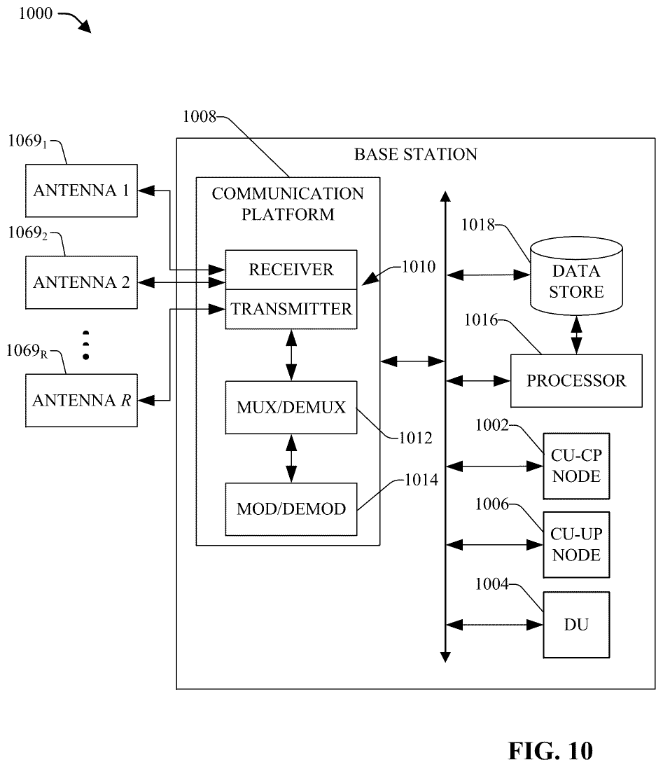

Turning to FIG. 10, FIG. 10 depicts a diagram of a non-limiting example base station 1000 that can desirably facilitate (e.g., enable) connections (e.g., wireless connections) and communication of information associated with devices, in accordance with various aspects and embodiments of the disclosed subject matter. In some embodiments, the base station 1000 can be a 5G or other NR base station (e.g., gNB or other NR-type or xG base station, wherein x can be a number greater than 5). In other embodiments, the base station 1000 can be a 4G or LTE base station, or some other type of base station (e.g., other type of access point).

With regard to a 5G or other NR base station, the base station 1000 can comprise a CU-CP node 1002 (e.g., a gNB or other NR-NB CU-CP node), one or more DUs (e.g., a gNB or other NR-NB DUs), including DU 1004, a desired number of CU-UP nodes (e.g., a gNB or other NR-NB CU-UP nodes), including CU-UP node 1006, and/or other network equipment. The CU-CP node 1002 can be associated or interfaced with the DUs (e.g., DU 1004) via an interface (e.g., F1-C interface) or connection. The CU-CP node 1002 can be associated or interfaced with the CU-UP nodes (e.g., CU-UP node 1006) via an interface (e.g., E1 interface) or connection. The one or more CU-UP nodes (e.g., CU-UP node 1006) can be associated or interfaced with the one or more DUs (e.g., DU 1004) via an interface (e.g., F1-U interface) or connection.

A DU (e.g., DU 1004) can provide support for lower layers of a protocol stack. For instance, a DU (e.g., DU 1004) can be a logical node that can host or handle baseband (e.g., PHY) and L2 (e.g., MAC and RLC layer) functionality associated with the base station 1000. A CU-UP node (e.g., CU-UP node 1006) can be a logical node that can host or handle data traffic between the core network 104 (e.g., 5G or other NR or xG core network) and the DU(s) (e.g., DU 1004) to which the particular CU-UP is connected. The CU-CP node 1002 can be a logical node that can host or handle L3 (e.g., RRC and PDCP layer) control plane functionality associated with the base station 1000.

In some embodiments, a device(s) (e.g., device(s) 110 and/or 112) can be connected to the base station 1000, via the DU 1004, wherein the CU-UP node 1006 and the DU 1004 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the data source) via the base station 1000.

The base station 1000 can receive and transmit signal(s) from and to wireless devices like access points (e.g., base stations, femtocells, picocells, or other type of access point), access terminals (e.g., UEs), wireless ports and routers, and the like, through a set of antennas 10691-1069R. In an aspect, the antennas 10691-1069R can be a part of a communication platform 1008, which comprises electronic components and associated circuitry that can provide for processing and manipulation of received signal(s) and signal(s) to be transmitted. In an aspect, the communication platform 1008 can include a receiver/transmitter 1010 that can convert signal from analog to digital upon reception, and from digital to analog upon transmission. In addition, receiver/transmitter 1010 can divide a single data stream into multiple, parallel data streams, or perform the reciprocal operation. In accordance with various embodiments, the communication platform 1008 can be, can comprise, or can be associated with an RU (e.g., a gNB or other NR-NB RU node).

In an aspect, coupled to receiver/transmitter 1010 can be a multiplexer/demultiplexer (mux/demux) 1012 that can facilitate manipulation of signal in time and frequency space. The mux/demux 1012 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 1012 can scramble and spread information (e.g., codes) according to substantially any code known in the art, e.g., Hadamard-Walsh codes, Baker codes, Kasami codes, polyphase codes, and so on. A modulator/demodulator (mod/demod) 1014 also can be part of the communication platform 1008, and can modulate information according to multiple modulation techniques, such as frequency modulation, amplitude modulation (e.g., M-ary quadrature amplitude modulation (QAM), with M a positive integer), phase-shift keying (PSK), and the like.

The base station 1000 also can comprise a processor(s) 1016 that can be configured to confer and/or facilitate providing functionality, at least partially, to substantially any electronic component in or associated with the base station 1000. For instance, the processor(s) 1016 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 1000 can include a data store 1018 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters) associated with devices; information relating to data, files, services, applications, communication network, core network, RANS, cells, devices, users, resources, communication sessions (e.g., PDU or other communication sessions), PDU session types, performance indicators, protocol layers, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced PDU session generation algorithms, enhanced data exchange algorithms, enhanced distributed, federated, and collaborative algorithms, AI algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on.

The processor(s) 1016 can employ one or more processors (e.g., one or more CPUs, accelerators, GPUs, ASICs, or other processors), microprocessors, or controllers) that can process information, and can be coupled to the data store 1018 in order to store and retrieve at least some of the information (e.g., information, such as algorithms, relating to multiplexing/demultiplexing or modulation/demodulation; information relating to radio link levels; information relating to data, files, services, applications, communication network, core network, RANs, cells, devices, users, resources, communication sessions (e.g., PDU or other communication sessions), PDU session types, performance indicators, protocol layers, distributed and federated learning, AI/ML-based models, AI-related data, training data, feedback information, measurement reports, predictions, inferences, device mobility predictions and determinations, device handover predictions and determinations, threshold (e.g., maximum, minimum, or other threshold) values, weight values, grants (e.g., downlink or uplink periodic grants or configured grants), DCI, congestion information or indicators, data processing operations, messages, notifications, alarms, alerts, preferences (e.g., user or client preferences), hash values, metadata, parameters, hyperparameters, traffic flows, tables, mappings, policies, the defined communication management criteria, algorithms (e.g., enhanced communication management algorithms, enhanced PDU session generation algorithms, enhanced data exchange algorithms, enhanced distributed, federated, and collaborative algorithms, AI algorithms, hash algorithms, data compression algorithms, data decompression algorithms, and/or other algorithm), interfaces, protocols, tools, and/or other information) desired to operate and/or confer functionality to the communication platform 1008 and/or other operational components of the base station 1000. The data store 1018 can comprise volatile memory and/or nonvolatile memory, such as described herein.

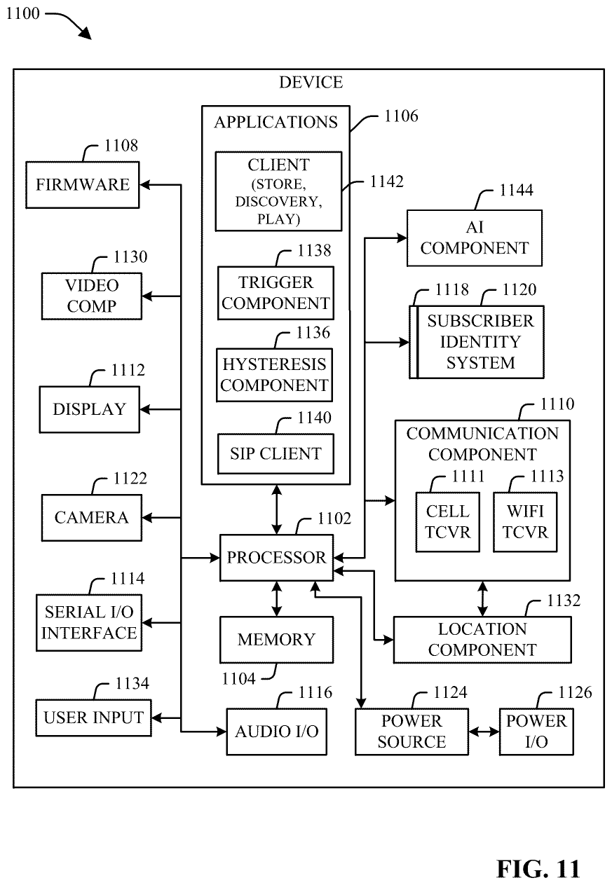

Referring to FIG. 11, FIG. 11 illustrates a diagram of a non-limiting example device 1100 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 1100 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 1100, can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 1100 can include a processor(s) 1102 for controlling and processing all onboard operations and functions. The processor(s) 1102 can comprise one or more processors (e.g., one or more CPUs, accelerators, GPUs, ASICs, or other processors), microprocessors, or controllers) that can process information associated with the device 1100. A memory 1104 can interface to the processor(s) 1102 for storage of data and one or more applications 1106 (e.g., a video player software, user feedback component software, or other application). Other applications can include voice recognition of predetermined voice commands that facilitate initiation of the user feedback signals. Still other applications can comprise an AI application. The applications 1106 can be stored in the memory 1104 and/or in a firmware 1108, and executed by the processor(s) 1102 from either or both the memory 1104 or/and the firmware 1108. The firmware 1108 can also store startup code for execution in initializing the device 1100. A communication component 1110 interfaces to the processor(s) 1102 to facilitate wired/wireless communication with external systems, e.g., cellular networks, VoIP networks, and so on. Here, the communication component 1110 can also include a suitable cellular transceiver 1111 (e.g., a global system for mobile communication (GSM), orthogonal frequency division multiple access (OFDMA), 4G, LTE, 5G, other NR, or other type of transceiver) and/or an unlicensed transceiver 1113 (e.g., Wi-Fi, WiMax) for corresponding signal communications. The device 1100 can be a device such as a cellular telephone, a PDA with mobile communications capabilities, and messaging-centric devices. The communication component 1110 also facilitates communications reception from terrestrial radio networks (e.g., broadcast), digital satellite radio networks, and Internet-based radio services networks.

The device 1100 includes a display 1112 for displaying text, images, video, telephony functions (e.g., a Caller ID function), setup functions, and for user input. For example, the display 1112 can also be referred to as a “screen” that can accommodate the presentation of multimedia content (e.g., music metadata, messages, wallpaper, graphics, etc.). The display 1112 can also display videos and can facilitate the generation, editing and sharing of video quotes. A serial I/O interface 1114 is provided in communication with the processor(s) 1102 to facilitate wired and/or wireless serial communications (e.g., USB, and/or IEEE 1394) through a hardwire connection, and other serial input devices (e.g., a keyboard, keypad, and mouse). This supports updating and troubleshooting the device 1100, for example. Audio capabilities are provided with an audio I/O component 1116, which can include a speaker for the output of audio signals related to, for example, indication that the user pressed the proper key or key combination to initiate the user feedback signal. The audio I/O component 1116 also facilitates the input of audio signals through a microphone to record data and/or telephony voice data, and for inputting voice signals for telephone conversations.

The device 1100 can include a slot interface 1118 for accommodating a SIC (Subscriber Identity Component) in the form factor of a card Subscriber Identity Module (SIM) or universal SIM 1120, and interfacing the SIM card 1120 with the processor(s) 1102. However, it is to be appreciated that the SIM card 1120 can be manufactured into the device 1100, and updated by downloading data and software.

The device 1100 can process IP data traffic through the communication component 1110 to accommodate IP traffic from an IP network such as, for example, the Internet, a corporate intranet, a home network, a person area network, etc., through an ISP or broadband cable provider. Thus, VOIP traffic can be utilized by the device 1100 and IP-based multimedia content can be received in either an encoded or a decoded format.

A video processing component 1122 (e.g., a camera) can be provided for decoding encoded multimedia content. The video processing component 1122 can aid in facilitating the generation, editing, and sharing of video quotes. The device 1100 also includes a power source 1124 in the form of batteries and/or an AC power subsystem, which power source 1124 can interface to an external power system or charging equipment (not shown) by a power I/O component 1126.

The device 1100 can also include a video component 1130 for processing video content received and, for recording and transmitting video content. For example, the video component 1130 can facilitate the generation, editing and sharing of video quotes. A location tracking component 1132 facilitates geographically locating the device 1100. As described hereinabove, this can occur when the user initiates the feedback signal automatically or manually. A user input component 1134 facilitates the user initiating the quality feedback signal. The user input component 1134 can also facilitate the generation, editing and sharing of video quotes. The user input component 1134 can include such conventional input device technologies such as a keypad, keyboard, mouse, stylus pen, and/or touch screen, for example.

Referring again to the applications 1106, a hysteresis component 1136 facilitates the analysis and processing of hysteresis data, which is utilized to determine when to associate with the access point. A software trigger component 1138 can be provided that facilitates triggering of the hysteresis component 1136 when the Wi-Fi transceiver 1113 detects the beacon of the access point. A SIP client 1140 enables the device 1100 to support SIP protocols and register the subscriber with the SIP registrar server. The applications 1106 can also include a client 1142 that provides at least the capability of discovery, play and store of multimedia content, for example, music.

The device 1100, as indicated above related to the communication component 1110, includes an indoor network radio transceiver 1113 (e.g., Wi-Fi transceiver). This function supports the indoor radio link, such as IEEE 802.11, for the dual-mode GSM device (e.g., device 1100). The device 1100 can accommodate at least satellite radio services through a device (e.g., handset device) that can combine wireless voice and digital radio chipsets into a single device (e.g., single handheld device).

In some embodiments, the device 1100 can comprise the AI component 1144 that can perform AI and/or ML functions and operations, and can generate, train, and/or update one or more AI models (e.g., AI models, ML models, neural network models, and/or other models, which can be local AI models of the device 1100), such as described herein. The AI component 1144 and/or the one or more AI-based models can generate AI-related data that can be communicated to the RAN or the core network (e.g., to the AF or AI component of or associated with the core network), and/or can receive AI-related data from the RAN or the core network (e.g., can receive AI-related data from the global AI component or global AI model of the RAN to facilitate training or updating a local AI model(s) of the device 1100), such as described herein.

It is to be appreciated and understood that one or more components (e.g., the devices, session manager component, AI component, base station, core network, or other component) of the systems (e.g., system 100, system 200, system 300, system 400, system 800, system 900, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

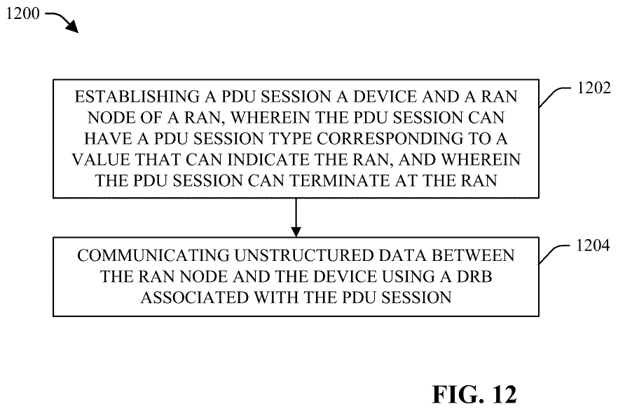

In view of the example systems and/or devices described herein, example methods that can be implemented in accordance with the disclosed subject matter can be further appreciated with reference to flowcharts in FIGS. 12-14. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 12 illustrates a flow chart of an example method 1200 that can desirably (e.g., automatically, dynamically, suitably, reliably, efficiently, enhancedly, and/or optimally) establish an enhanced PDU session between the RAN and a device to facilitate communication of data (e.g., unstructured data) between the RAN and the device, and facilitate distributed and federated learning, in accordance with various aspects and embodiments of the disclosed subject matter. The method 1200 can be employed by, for example, a system comprising the RAN, the core network, and the session manager component that can comprise or be associated with the processor component, the data store, and/or other components.

At 1202, a PDU session can be established between a device and a RAN node of a RAN, wherein the PDU session can have a PDU session type corresponding to a value that can indicate the RAN, and wherein the PDU session can terminate at the RAN. The session manager component can establish, or initiate or facilitate establishing, the PDU session between the device and the RAN node (e.g., base station or gNB) of the RAN, wherein the PDU session can have the PDU session type that can correspond to the value that can indicate the RAN, and wherein the PDU session can terminate at the RAN.

At 1204, unstructured data can be communicated between the RAN node and the device using a DRB associated with the PDU session. With the PDU session established, using the DRB associated with the PDU session, the unstructured data can be communicated between the RAN node and the device. In some embodiments, the unstructured data can comprise AI-related data (e.g., AI-related data generated by the global AI model associated with the RAN, or AI-related data generated by the local AI model associated with the device).

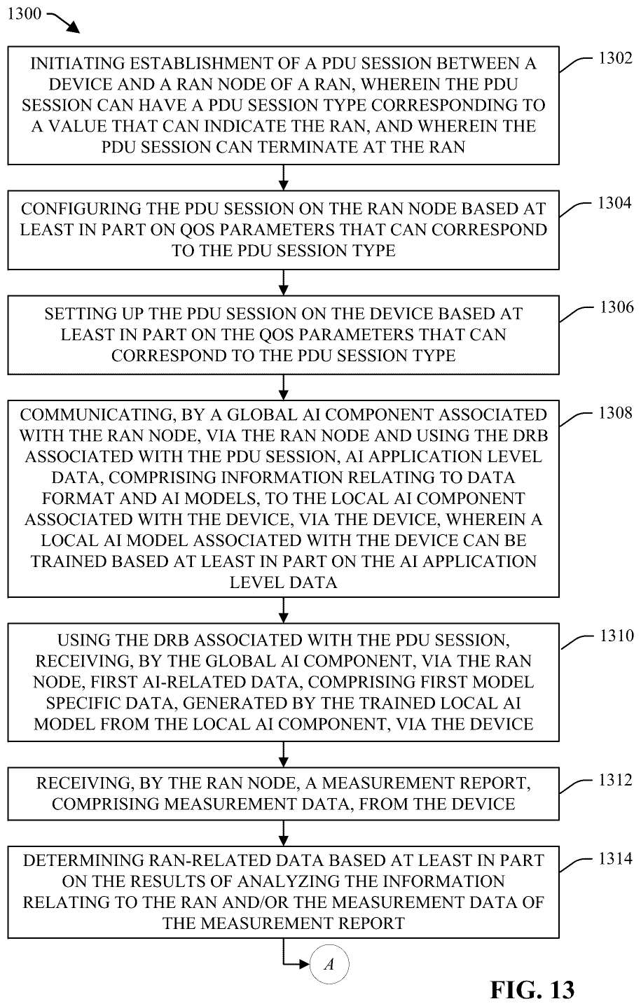

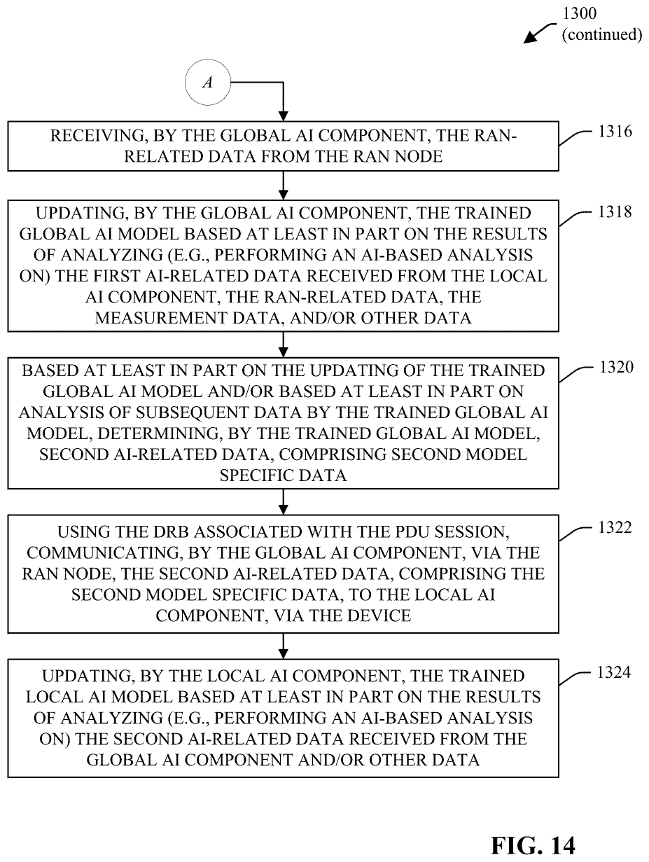

FIGS. 13 and 14 depict a flow chart of another example method 1300 that can desirably (e.g., automatically, dynamically, suitably, reliably, efficiently, enhancedly, and/or optimally) establish an enhanced PDU session between the RAN and a device to facilitate communication of data (e.g., unstructured data) between the RAN and the device, and facilitate distributed and federated learning, in accordance with various aspects and embodiments of the disclosed subject matter. The method 1300 can be employed by, for example, a system comprising the RAN, the core network, the session manager component, and the global AI component (e.g., employing the model manager component) that can comprise or be associated with the processor component, the data store, and/or other components.

At 1302, establishment of a PDU session between a device and a RAN node of a RAN can be initiated, wherein the PDU session can have a PDU session type corresponding to a value that can indicate the RAN, and wherein the PDU session can terminate at the RAN. For instance, the core network (e.g., the AMF of the core network) can receive a PDU session establishment request from the device, wherein the request can comprise the value that can indicate the RAN as the PDU session type for the PDU session. In response to the request, the session manager component can establish, or initiate or facilitate establishing, the PDU session between the device and the RAN node (e.g., base station or gNB) of the RAN, wherein the PDU session can have the PDU session type that can correspond to the value that can indicate the RAN, and wherein the PDU session can terminate at the RAN.

At 1304, the PDU session can be configured on the RAN node based at least in part on QoS parameters that can correspond to the PDU session type. The session manager component (e.g., of or associated with the AMF of the core network) can communicate the QoS parameters to the RAN node, and coordinate with the RAN node to configure the PDU session on the RAN node based at least in part on the QoS parameters.

At 1306, the PDU session can be set up on the device based at least in part on the QoS parameters that can correspond to the PDU session type. The session manager component can communicate a PDU session establishment accept message, comprising the QoS parameters, to the device to indicate that the request for the PDU session, with the PDU session type set to RAN, has been accepted and to facilitate setting up (e.g., configuring) the PDU session, including setting up resources, for the device. Once the PDU session is set up on the device, the device can communicate a PDU session resource setup response message to the AMF (e.g., to the session manager component associated with the AMF) to indicate that the setting up of the PDU session, including the setting up of resources for the PDU session, on the device has been successfully completed.

At 1308, a global AI component associated with the RAN node can communicate, via the RAN node and using the DRB associated with the PDU session, AI application level data, comprising information relating to data format and AI models, to the local AI component associated with the device, via the device, wherein a local AI model associated with the device can be trained based at least in part on the AI application level data. The model manager component of the global AI component can manage or facilitate managing the training and updating of AI models, including the global AI component and the local AI model. For instance, the global AI component, employing its model manager component, can facilitate managing the training of the local AI model of the device to have the global AI component (e.g., the AI application of or associated with the global AI component) communicate, via the RAN node and using the DRB associated with the PDU session, the AI application level data, comprising the information relating to the data format and the AI models, and/or training data, to the local AI component, via the device. In some embodiments, the AI application level data can be unstructured AI application level data. The local AI model associated with the device can be trained, based at least in part on the AI application level data, and/or the training data (e.g., based at least in part on inputting such data to and/or analyzing such data by the local AI model), to generate the trained local AI model.

At 1310, using the DRB associated with the PDU session, the global AI component can receive, via the RAN node, first AI-related data, comprising first model specific data, generated by the trained local AI model from the local AI component, via the device. The model manager component of the global AI component can manage the model training to have the global AI component receive, via the RAN node, the first AI-related data generated by the trained local AI model from the local AI component, via the device. In some embodiments, the first AI-related data can be first unstructured AI-related data.

At 1312, a measurement report, comprising measurement data, can be received from the device by the RAN node. The device can measure communication conditions (e.g., signal quality, QoS, or other communication conditions or parameters) associated with the device, and can generate the measurement report based at least in part on such measurements of the communication conditions or parameters. The device can communicate the measurement report to the RAN node, which can receive such measurement report.

At 1314, RAN-related data (e.g., RAN-specific data) can be determined based at least in part on the results of analyzing information (e.g., measurements) relating to the RAN and/or the measurement data of the measurement report. The RAN (e.g., the RAN node of the RAN) can determine and generate the RAN-related data based at least in part on the results analyzing the information relating to the RAN and/or the measurement data of the received measurement report. At this point, the method 1300 can proceed to reference point A, wherein the method 1300 can proceed from reference point A as depicted in FIG. 14 and described herein.

At 1316, the global AI component can receive the RAN-related data from the RAN node. At 1318, the global AI component (e.g., employing the global AI application, and as managed by the model manager component) can update (e.g., further train or refine training of) the trained global AI model based at least in part on the results of analyzing (e.g., performing an AI-based analysis on) the first AI-related data received from the local AI component, the RAN-related data, the measurement data, and/or other data (e.g., feedback information, and/or other data received from another device or another base station). The global AI component can input (e.g., apply) the first AI-related data, the RAN-related data, the measurement data, and/or the other data into the trained global AI model. The trained global AI model can perform an AI-based analysis on the first AI-related data, the RAN-related data, the measurement data, and/or the other data. Based at least in part on the results of such analysis, the trained global AI model can be updated.

At 1320, based at least in part on the updating of the trained global AI model and/or based at least in part on analysis of subsequent data by the trained global AI model, the trained global AI model can determine second AI-related data, comprising second model specific data. For instance, the model manager component can manage the trained global AI model to have the trained (and updated) global AI model determine and generate the second AI-related data relating to the device, the RAN, and/or the core network based at least in part on the updating of the trained global AI model and/or based at least in part on the analysis of the subsequent data by the trained global AI model, wherein the subsequent data can relate to operation of the device, the RAN, and/or the core network, such as described herein. In some embodiments, the second AI-related data can be second unstructured AI-related data.

At 1322, using the DRB associated with the PDU session, the second AI-related data, comprising the second model specific data, can be communicated by the global AI component, via the RAN node, to the local AI component, via the device. In some embodiments, the model manager component can manage the model training to have the global AI component communicate, via the RAN node, the second AI-related data to the local AI component, via the device.

At 1324, the local AI component (e.g., employing the local AI application, and as managed by the model manager component of the local AI component of the device) can update (e.g., further train or refine training of) the trained local AI model based at least in part on the results of analyzing (e.g., performing an AI-based analysis on) the second AI-related data received from the global AI component and/or other data (e.g., measurement data, feedback information, or other information). The local AI component (e.g., employing its model manager component and/or trainer component) can input (e.g., apply) the second AI-related data and/or the other data into the trained local AI model. The trained local AI model can perform an AI-based analysis on the second AI-related data and/or the other data. Based at least in part on the results of such analysis, the trained local AI model can be updated.

The global AI model associated with the RAN and the local AI model associated with the device can continue to be iteratively updated (e.g., further trained or refined), as managed by the model manager component of the global AI component and/or the model manager component of the local AI component, based at least in part on the respective results of respective analyses of the respective AI-related data exchanged between the global AI model and the local AI model and/or other data, such as described herein.

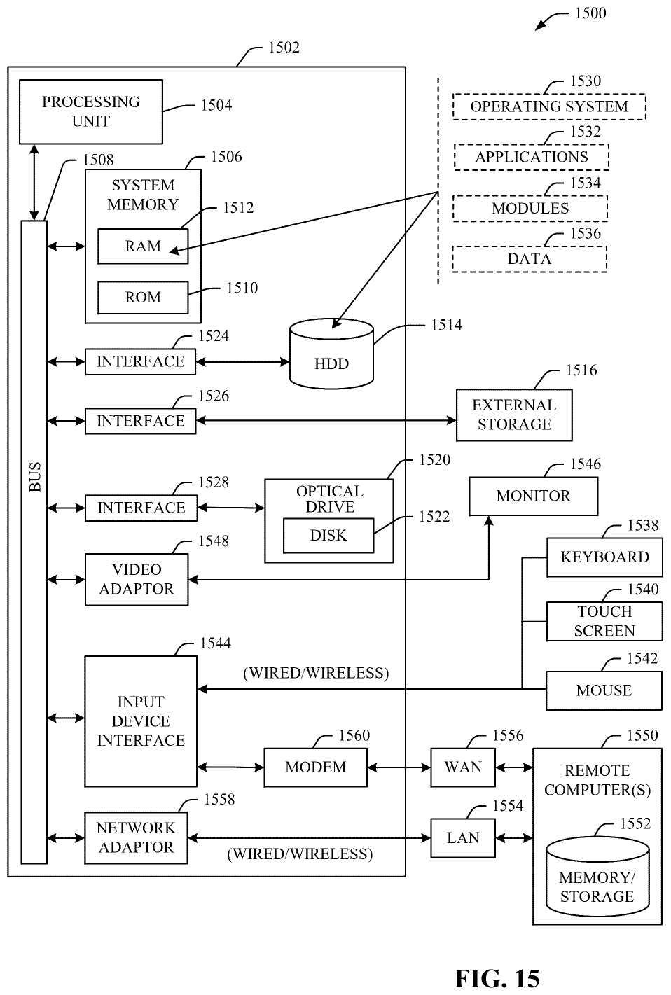

In order to provide additional context for various embodiments described herein, FIG. 15 and the following discussion are intended to provide a brief, general description of a suitable computing environment 1500 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1520 (e.g., which can read or write from a CD-ROM disc, a DVD, a BD, etc.). While the internal HDD 1514 is illustrated as located within the computer 1502, the internal HDD 1514 also can be configured for external use in a suitable chassis (not shown). Additionally, while not shown in environment 1500, a solid state drive (SSD) could be used in addition to, or in place of, an HDD 1514. The HDD 1514, external storage device(s) 1516 and optical disk drive 1520 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are examples and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556, e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, base station, UPF, session manager component, AI component, model manager component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
initiating, by a system comprising at least one processor, establishing a protocol data unit session between a device and a radio access network node of a radio access network, the protocol data unit session having a protocol data unit session type corresponding to a value that indicates the radio access network, wherein the protocol data unit session terminates at the radio access network; and
facilitating, by the system and using a data radio bearer associated with the protocol data unit session, communicating unstructured data between the radio access network node and the device.

2. The method of claim 1, wherein the protocol data unit session does not utilize a user plane tunnel associated with a user plane function node of a core network.

3. The method of claim 1, wherein the unstructured data comprises unstructured artificial intelligence-related data, and wherein the method further comprises:
generating, by a global artificial intelligence node of the radio access network of the system, the unstructured artificial intelligence-related data comprising format data and model data relating to artificial intelligence models;
facilitating, by a service-data-adaptation-protocol layer of the radio access network node of the system, receiving the unstructured artificial intelligence-related data from the global artificial intelligence node; and
facilitating, by the system and using the data radio bearer, communicating the unstructured artificial intelligence-related data from the radio access network node to the device, wherein a local artificial intelligence model of the device is trained based on the unstructured artificial intelligence-related data comprising the format data and the model data.

4. The method of claim 1, wherein the unstructured data comprises unstructured artificial intelligence-related data, and wherein the method further comprises:
facilitating, by the radio access network node of the system and using the data radio bearer, receiving the unstructured artificial intelligence-related data and a measurement report from the device, wherein a trained local artificial intelligence model associated with the device generates the unstructured artificial intelligence-related data, and wherein the measurement report comprises measurement data relating to a measurement relating to a communication condition associated with the device; and
facilitating, by a global artificial intelligence node of the radio access network of the system, receiving radio access network-related data from the radio access network node, wherein the radio access network-related data is determined based on condition data relating to a condition associated with the radio access network node or based on the measurement data.

5. The method of claim 4, further comprising:
facilitating, by the global artificial intelligence node of the radio access network of the system, receiving the unstructured artificial intelligence-related data from the radio access network node using a service-data-adaptation-protocol layer of the radio access network node.

6. The method of claim 4, wherein the unstructured artificial intelligence-related data is first unstructured artificial intelligence-related data, wherein the unstructured data comprises the first unstructured artificial intelligence-related data and second unstructured artificial intelligence-related data, and wherein the method further comprises:
training, by the global artificial intelligence node of the radio access network of the system, a global artificial intelligence model of the radio access network, based on analysis of the first unstructured artificial intelligence-related data, the radio access network-related data, or the measurement data by the global artificial intelligence model, to generate a trained or updated global artificial intelligence model;
determining, by the trained or updated global artificial intelligence model of the radio access network of the system, the second unstructured artificial intelligence-related data; and
facilitating, by the radio access network node of the system and using the data radio bearer, communicating the second unstructured artificial intelligence-related data to the device, wherein the trained local artificial intelligence model associated with the device is updated based on the second unstructured artificial intelligence-related data.

7. The method of claim 6, further comprising:
facilitating, by the global artificial intelligence node of the radio access network of the system, communicating the second unstructured artificial intelligence-related data to a service-data-adaptation-protocol layer of the radio access network node to facilitate the communicating of the second unstructured artificial intelligence-related data to the device.

8. The method of claim 6, wherein the first artificial intelligence-related data comprises first artificial intelligence model data, first machine learning model data, or first neural network model data, and
wherein the second artificial intelligence-related data comprises second artificial intelligence model data, second machine learning model data, or second neural network model data.

9. The method of claim 6, wherein the trained or updated global artificial intelligence model comprises a trained or updated global machine learning model or a trained or updated global neural network model, and
wherein the trained local artificial intelligence model comprises a trained local machine learning model or a trained local neural network model.

10. The method of claim 6, further comprising:
based on input data input to and analyzed by the trained or updated local artificial intelligence model, inferring or determining, by the trained or updated global artificial intelligence model of the radio access network of the system, an action to be performed by the radio access network node or the device.

11. The method of claim 1, further comprising:
facilitating, by the system, receiving a request to establish the protocol data unit session between the device and the radio access network node, wherein the request indicates the value that indicates the protocol data unit session type corresponds to the radio access network;
initiating, by the system, configuring of the protocol data unit session at the radio access network node based on quality-of-service parameters that correspond to the protocol data unit session type; and
initiating, by the system, configuring of the protocol data unit session at the device based on the quality-of-service parameters that correspond to the protocol data unit session type.

12. The method of claim 11, wherein a quality-of-service value is associated with the quality-of-service parameters, and wherein the quality-of-service value indicates that a service associated with the quality-of-service parameters is an artificial intelligence or machine learning application.

13. A system, comprising:
at least one memory that stores computer executable components; and
at least one processor that executes computer executable components stored in the at least one memory, wherein the computer executable components comprise:
a radio access network node of a radio access network; and
a session manager that initiates establishment of a protocol data unit session between a user equipment and the radio access network node, wherein the protocol data unit session is associated with a protocol data unit session type that corresponds to a type value associated with the radio access network to indicate that the protocol data unit session terminates at the radio access network node, and
wherein the radio access network node, using a data radio bearer associated with the protocol data unit session, transmits unstructured information to the user equipment.

14. The system of claim 13, wherein the computer executable components further comprise:
an artificial intelligence node that employs an artificial intelligence or machine learning application to train or update a global artificial intelligence model of the radio access network to generate a trained or updated global artificial intelligence model.

15. The system of claim 14, wherein the radio access network comprises a radio access network server node, the radio access network node, and the artificial intelligence node that are communicatively connected to each other, and wherein the radio access network server node comprises an accelerator unit, a graphics processing unit, or an application specific integrated circuit.

16. The system of claim 14, wherein the radio access network node is associated with a first pod, wherein the artificial intelligence node or the artificial intelligence or machine learning application is associated with a second pod, and wherein the first pod is communicatively connected to the second pod to facilitate communication of a portion of the unstructured information between the first pod and the second pod.

17. The system of claim 14, wherein the unstructured information comprises unstructured artificial intelligence-related information, wherein the radio access network node receives, using the data radio bearer, measurement information from the user equipment, wherein the measurement information relates to a measurement of a condition associated with the user equipment,
wherein the radio access network node receives, using the data radio bearer and via the user equipment, the unstructured artificial intelligence-related information from a trained local artificial intelligence model of the user equipment,
wherein the radio access network node determines radio access network-related information based on the measurement information or a network-related condition associated with the radio access network, and
wherein the artificial intelligence or machine learning application trains or updates the global artificial intelligence model, based on the unstructured artificial intelligence-related information, the radio access network-related information, or the measurement information, to generate the trained or updated global artificial intelligence model.

18. The system of claim 17, wherein the unstructured information comprises the first unstructured artificial intelligence-related information and second unstructured artificial intelligence-related information,
wherein the trained or updated global artificial intelligence model determines the second unstructured artificial intelligence-related information based on the training or updating, or based on analysis of input information input to and analyzed by the trained or updated global artificial intelligence model, wherein the input information relates to the radio access network or the user equipment, and
wherein the radio access network node, using the data radio bearer, transmits the second unstructured artificial intelligence-related information to the user equipment to facilitate updating the trained local artificial intelligence model based on the second unstructured artificial intelligence-related information.

19. A non-transitory machine-readable medium, comprising executable instructions that, when executed by at least one processor, facilitate performance of operations, comprising:
facilitating a protocol data unit session between a user equipment and a base station of a radio access network, the protocol data unit session associated with a protocol data unit session type corresponding to a session type value that indicates the radio access network, wherein the protocol data unit session terminates at the base station; and
communicating, using a data radio bearer associated with the protocol data unit session, unstructured data, comprising unstructured artificial intelligence-related data, between the base station and the user equipment.

20. The non-transitory machine-readable medium of claim 19, wherein the unstructured artificial intelligence-related data comprises first unstructured artificial intelligence-related data and second unstructured artificial intelligence-related data, and wherein the operations further comprise:
receiving, by the base station and using the data radio bearer, the first unstructured artificial intelligence-related data from the user equipment, wherein a trained local artificial intelligence model associated with the user equipment generates the first unstructured artificial intelligence-related data;
training or updating a global artificial intelligence model of the radio access network, based on analysis of the first unstructured artificial intelligence-related data or first data relating to the radio access network or the user equipment, to generate a trained or updated global artificial intelligence model;
determining, by the trained or updated global artificial intelligence model, the second unstructured artificial intelligence-related data based on the training or updating, or based on analysis of second data relating to the radio access network or the user equipment; and
communicating, using the data radio bearer, the second unstructured artificial intelligence-related data from the base station to the user equipment to facilitate updating the trained local artificial intelligence model based on the second unstructured artificial intelligence-related data.
